(19) United States
(12) Patent Application Publication
(10) Pub. No.: US 2024/0112063 A1
(43) Pub. Date: Apr. 4, 2024

(54) HIGH-ACCURACY ESTIMATION OF GROUND STATE ENERGY USING EARLY FAULT-TOLERANT QUANTUM COMPUTERS

(71) Applicant: Zapata Computing, Inc., Boston, MA (US)

(72) Inventors: Guoming Wang, North York (CA); Peter Douglas Johnson, Portland, ME (US); Ruizhe Zhang, Austin, TX (US); Daniel Stilck França, Lyon (FR); Shuchen Zhu, Chantilly, VA (US)

(21) Appl. No.: 18/463,813

(22) Filed: Sep. 8, 2023

Related U.S. Application Data
(60) Provisional application No. 63/405,206, filed on Sep. 9, 2022.

(51) Int. Cl. G06N 10/80; G06N 10/20

(52) U.S. Cl. CPC G06N 10/80; G06N 10/20

(57) ABSTRACT

A method and system for estimating the ground state energy of a quantum Hamiltonian. The disclosed algorithm may run on any hardware and is suited for early fault tolerant quantum computers. The algorithm employs low-depth quantum circuits with one ancilla qubit with classical post-processing. The algorithm first draws samples from Hadamard tests in which the unitary is a controlled time evolution of the Hamiltonian. The samples are used for evaluating the convolution of the spectral measure and a filter function, and then inferring the ground state energy from this convolution. Quantum circuit depth is linear in the inverse spectral gap and poly-logarithmic in the inverse target accuracy and inverse initial overlap. Runtime is polynomial in the inverse spectral gap, inverse target accuracy, and inverse initial overlap. The algorithm produces a highly-accurate estimate of the ground state energy with reasonable runtime using low-depth quantum circuits. Other properties of a Hamiltonian may also be computed with this method.

### CROSS-REFERENCE TO RELATED APPLICATIONS

This application claims priority to U.S. Prov. Pat. App. No. 63/405,206, filed on Sep. 9, 2022, entitled, “High-Accuracy Estimation of Ground State Energy Using Early Fault-Tolerant Quantum Computers,” which is hereby incorporated by reference herein.

### FIELD OF INVENTION

The disclosed technology is directed to a method and system for estimating ground state energy for molecules and materials using quantum computers. The disclosed technology uses a low-depth quantum circuit and a quantum-classical hybrid algorithm for efficiently estimating ground state with high accuracy.

### BACKGROUND

Quantum computers have been improving at a rapid rate, with increasing demand for quantum algorithms that solve real-world problems of high value. As quantum technology is commercialized, quantum computing technology will include the development of new molecules and materials, including new drug discoveries. One important application of quantum computing is the simulation of materials and molecules, which are inherently quantum mechanical.

Quantum algorithm development for quantum chemistry and materials has been focused on ground state energy estimation. This problem is mathematically formulated as estimating the lowest eigenvalue of the Hamiltonian matrix that characterizes the physical system. One of the first quantum chemistry applications of quantum computers was the use of quantum phase estimation for estimating the ground state energy of small molecules.

Known algorithms developed for use in quantum computers have a major drawback. The algorithms are designed and developed for idealistic quantum computers, which require high-depth quantum circuits. Previously methods for the ground state energy estimation require circuit depths that scale as 1/ϵ to reach accuracy ϵ. With high-depth quantum circuits, errors propagate more readily, making them impractical for implementation on present-day quantum computers. There is a need for a method and system for reliably estimating ground state energy with high accuracy, which can be implemented on quantum computers having low-depth quantum circuits.

### SUMMARY

Quantum computers have been proven useful in solving computational problems that are difficult for classical computers. One of the areas of current interest is solving problems related to ground state energy estimation (GSEE), which is useful in understanding molecular structure and material properties. Although the science of quantum computing is evolving at a fast rate, there is currently a need to address existing problems with currently available quantum computer architecture hardware and algorithm methods.

Estimating ground state energies of quantum Hamiltonians is of immense importance in condensed matter physics, quantum chemistry, and quantum information. The disclosed technology may be used to study the properties of molecules and other physical systems in these fields, which could potentially lead to development of new materials, design of new quantum devices, and the discovery of new drugs.

The disclosed technology provides a different approach to ground state energy estimation (GSEE) including a method and algorithm for estimating the ground state energy of a quantum Hamiltonian on an early fault-tolerant quantum computer. The disclosed algorithm employs low-depth quantum circuits with one ancilla qubit and classical post-processing procedure to achieve this goal.

More specifically, the disclosed technology includes a method for ground state energy estimation algorithms for which the circuit depth is proportional to 1/Δ, where Δ is a lower bound on the energy gap of the Hamiltonian, and uses just one auxiliary or ancilla qubit. The algorithm first draws samples from Hadamard tests in which the unitary is a time evolution of the Hamiltonian. The algorithm then uses these samples to evaluate the convolution of the spectral measure and a filter, which may be a Gaussian derivative filter, and infers the ground state energy from this convolution.

In the discussion that follows, the term low-depth quantum circuit may be used interchangeably with shallow-depth quantum circuit. A low-depth quantum circuit is a quantum circuit with a minimized count of circuit elements, less than the number of circuit elements used in prior approaches.

In another aspect of the disclosed technology, a ground state energy estimation algorithm may take advantage of larger available circuit depths to reduce the total runtime. By setting α∈ and the depth proportional to ϵ^{-α}Δₜᵣᵤₑ^{-+α} the resulting total runtime is [symbol] (Θ⁻²ϵ^{-2+α}Δₜᵣᵤₑ^{-+α}), where η is the ground state overlap. This is highly significant in that the disclosed algorithm becomes a promising candidate for realizing quantum advantage in the era of early fault-tolerant quantum computing (EFTQC).

The maximal depths of the quantum circuits in the disclosed algorithm and method are linear in the inverse spectral gap and poly-logarithmic in the inverse target accuracy and inverse initial overlap. The overall runtime of the disclosed algorithm is polynomial in the inverse spectral gap, inverse target accuracy, and inverse initial overlap.

The disclosed method and algorithm provide advantages over previous methods. In the disclosed technology, the target accuracy is smaller than the spectral gap, producing a highly-accurate estimate of the ground state energy in a reasonable amount of time while using low-depth quantum circuits.

### Prior Approaches

The disclosed technology may be better understood by comparing it to prior approaches of ground state energy estimation (GSEE), while identifying the shortcomings of each approach.

The most popular method for GSEE is quantum phase estimation (QPE). This method gives an accurate estimate of ground state energy. However, it requires deep quantum circuits with multiple ancilla qubits, which makes the implementation of this algorithm challenging.

The second popular method for GSEE is the variational quantum eigensolver (VQE). This method requires only low-depth quantum circuits, making it easy to implement on near noisy intermediate scale quantum (NISQ) devices. However, the quality of the output using this method cannot be guaranteed, and there is empirical evidence that it does not perform well for many Hamiltonians.

The third known method has been proposed for handling GSEE on early fault-tolerant quantum computers. This method incorporates algorithms that require lower-depth quantum circuits than QPE and do not need many ancilla qubits. This arrangement generally guarantees accurate estimates of ground state energy. However, the depths of the quantum circuits in these algorithms are proportional to the inverse error. Therefore, in order to estimate ground state energy with high accuracy, the algorithms demand deep quantum circuits, and are thus impractical.

The disclosed method and algorithm for GSEE employ lower-depth quantum circuits with one ancilla qubit and a classical post-processing procedure, and has been proven to produce highly-accurate results. With the present technology, information is extracted from the outcomes of the quantum circuits in a significantly different way from prior methods. Specifically, the disclosed method evaluates the convolution of the spectral measure and a filter, which may be a Gaussian derivative filter, by using the outcomes of Hadamard tests, and it is possible to infer the ground state energy from this convolution. This innovation makes possible the high-accuracy estimating of ground state energy using lower-depth quantum circuits than in previous methods.

In one embodiment of the disclosed technology, a method for estimating ground state energy includes convolving the spectral measure and a filter and inferring the ground state energy from this convolution. This convolution may be evaluated by using the outcomes of Hadamard tests. Therefore, a high-accuracy estimate of the ground state energy is achieved when using lower-depth quantum circuits than in prior methods.

In another embodiment, the disclosed technology may also be useful for computing other properties of a Hamiltonian besides the ground state energy. In this embodiment, the preferred filter may be another function such as a Gaussian filter.

### BRIEF DESCRIPTION OF THE DRAWINGS

In the drawings, like reference characters designate like parts throughout the different views. Also, the drawings are not necessarily to scale, with an emphasis instead generally being placed upon illustrating the principles of the technology disclosed. In the following description, various implementations of the technology disclosed are described with reference to the following drawings.

FIG. 1 is a diagram of a quantum computer according to one embodiment of the present invention;

FIG. 2A is a flowchart of a method performed by the quantum computer of FIG. 1 according to one embodiment of the present invention;

FIG. 2B is a diagram of a hybrid quantum-classical computer which performs quantum annealing according to one embodiment of the present invention; and

FIG. 3 is a diagram of a hybrid quantum-classical computer according to one embodiment of the present invention.

FIG. 4 is a simplified block diagram of the disclosed technology for ground state energy estimation;

FIG. 5 illustrates the disclosed algorithm and method in flowchart form;

FIG. 6 illustrates maximal evolution time ( [symbol] ₘₐₓ) vs. total evolution time ( [symbol] ₜₒₜ) of the early fault-tolerant GSEE algorithms;

FIG. 7 shows a Hadamard test circuit parameterized by the Hamiltonian evolution time T;

FIG. 8 is a plot of a convolution according to one embodiment of the present invention, using a Gaussian filter;

FIG. 9 is a plot of a convolution according to one embodiment of the present invention, using a Gaussian derivative filter;

FIG. 10 illustrates the convolution evaluation data structure algorithm in pseudocode; and

FIG. 11 illustrates the low-depth ground state energy estimation algorithm in pseudocode.

### DETAILED DESCRIPTION

The following detailed description is made with reference to the Figures. Sample implementations are described to illustrate the technology disclosed, not to limit its scope, which is defined by the claims. Those of ordinary skill in the art will recognize a variety of equivalent variations on the description that follows.

In one aspect of the disclosed technology, an algorithm is provided for ground state energy estimation (GSEE) using present-generation quantum technology. The disclosed technology includes an algorithm that operates with low-depth quantum circuits. The present technology improves on earlier algorithms and quantum circuits by providing a highly accurate, high-probability, low-circuit-depth solution for ground state energy estimation, which can be implemented on early fault-tolerant quantum computers.

### Overview

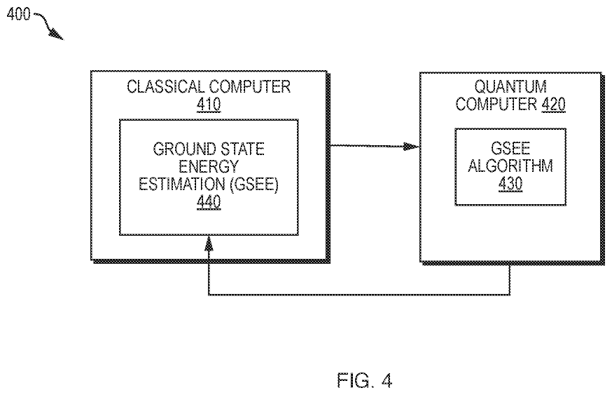

FIG. 4 illustrates the basic structure of the computer system that implements the method and system disclosed. In one embodiment, this algorithm may be implemented with or as part of a hybrid quantum-classical computer (HQC) 400. A classical computer 410 provides instructions and parameters for a quantum computer component 420. And algorithm 430 implements the disclosed method for ground state energy estimation (GSEE), followed by post-processing 440 in the classical computer 410.

In one embodiment of a method for ground state energy estimation, on a quantum computer, an initial quantum state with qubit registers and one ancilla qubit is prepared. Hadamard tests are applied in which the unitary is a time evolution of the Hamiltonian. Outcome samples are derived from the Hadamard tests. Using the outcome samples, the convolution of the spectral measure and a filter are evaluated. In one embodiment, the filter is a Gaussian derivative filter. The ground state energy is inferred from the convolution.

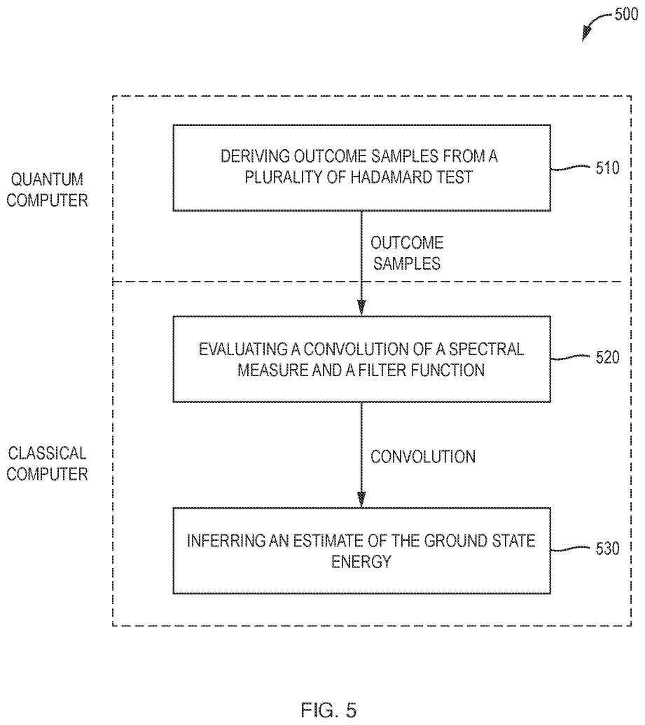

Referring now to FIG. 5, a block diagram is shown of the disclosed method for ground state energy estimation (GSEE) 500 according to one embodiment of the present invention. In step 510, on a quantum computer, outcome samples are derived from a plurality of Hadamard tests in which a unitary is a time evolution of the Hamiltonian. In step 520, on a classical computer, a convolution of a spectral measure and a filter function from the outcome samples are evaluated. In step 530, on the classical computer, an estimate of the ground state energy is inferred from the convolution.

### Early Fault-Tolerant GSEE Algorithms

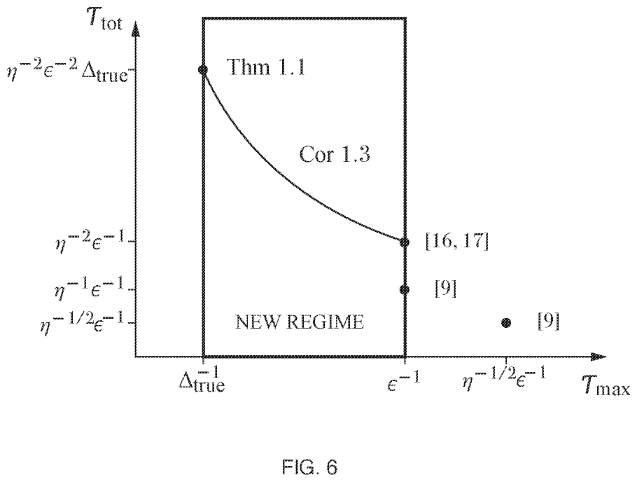

FIG. 6 illustrates maximal evolution time ( [symbol] ₘₐₓ) vs. total evolution time ( [symbol] ₜₒₜ) of the early fault-tolerant GSEE algorithms. For simplicity, all the poly-logarithmic factors are ignored. The orange dot corresponds to the disclosed [symbol] -depth GSEE algorithm, and the curve shows a smooth tradeoff between [symbol] ₘₐₓ and [symbol] ₜₒₜ. The rightmost dot indicates an algorithm requiring multiple ancilla qubits and multi-qubit controlled operations, whereas the disclosed algorithm uses a single ancilla qubit.

### The GSEE Algorithm

Ground state energy estimation algorithms typically use several key parameters determined by the problem instance and solution specifications. The problem instance is given by a Hamiltonian H, and a quantum state ρ that approximates the ground state of H. Three parameters relevant to GSEE algorithms are ϵ, the target accuracy of the ground state energy estimate, A, a lower bound on the energy gap (the difference between the smallest and next-smallest eigenvalue) of H, and η, a lower bound on the overlap of ρ with the ground state.

Existing methods for estimating ground state energy require circuit depths that scale as Õ(ϵ⁻¹η⁻²). There are methods which improve the circuit depth scaling down to Õ(ϵ⁻¹); however, additional costs need to be paid in terms of ancilla qubits and multi-qubit control operations. Such methods require the large gate counts of greater than 10¹⁰. The timeline is uncertain for realizing hardware architectures needed to implement prior methods that can be applied to solving useful problem instances. The present technology solves this problem.

As stated earlier, when considering chemical system sizes of industrial relevance, alternative methods, such as using the variational quantum eigensolver (VQE) algorithm, have runtime requirements too high to make the method practical.

The disclosed technology fulfills the need for ground state energy estimation algorithms which require modest circuit depths while also having provable performance guarantees.

In this section, an overview is provided for the GSEE low circuit depth algorithm for GSEE. The formulation of the GSEE problem is first discussed. Then, the discussion proceeds to how to overcome the barrier of the quantum circuit depth in previous algorithms, ending with the general approach for efficiently evaluating the convolution.

Problem formulation. Suppose a classical description of a quantum Hamiltonian H is given. The Hamiltonian has an (unknown) spectral decomposition H=Σⱼ₌₀^{N-1}Eⱼ|Eⱼ [symbol] [symbol] Eⱼ|, where E₀≤E₂≤. . . ≤E_{N-1} are the eigenvalues of H, and the |Eⱼ [symbol] 's are orthonormal eigenstates of H. Let ρ be an easy-to-prepare state (of the same dimension as H). Let pⱼ= [symbol] Eⱼ|ρ|Eⱼ [symbol] be the overlap between ρ and |Eⱼ [symbol] , for 0≤j≤N−1. Two numbers η∈(0,1) and Δ>0 are given such that p₀= [symbol] E₀|ρ|E₀ [symbol] ≥η and E₁−E₀≥Δ. The goal is to estimate E₀ with accuracy ϵ and confidence 1−δ, i.e. to output a sample from a random variable E₀ such that

[symbol]

[|Ê₀−E₀|>ϵ]<δ, (1)

for given small ϵ>0 and δ∈(0,1). Furthermore, it is desirable to achieve this result using only Hadamard tests (in which the unitary operation is controlled-e^{iHt} for some small t∈ [symbol] ) and classical post-processing.

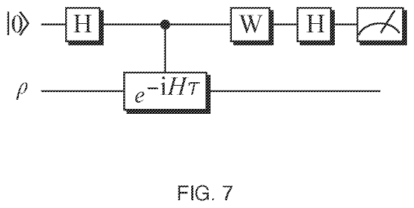

The quantum circuit for the Hadamard test is illustrated in FIG. 7. This is a known technique, but in the disclosed technology is used in a novel way. Referring to FIG. 7, let b∈{0, 1} be the measurement outcome of the Hadamard test circuit. Then the expectation [symbol] [(−1)^{b}] equals the real or imaginary part of tr[ρe^{-iHτ}] depending on whether W=I or W=S† where S is the phase gate.

### Previous Early Fault-Tolerant GSEE Methods

The main idea is to reduce the problem of estimating the ground state energy to locating the first non-zero point of a function. More specifically, let

$$p ( x ) = {\sum }_{j = 0}^{N - 1} {p}_{j} δ ( x - {E}_{j} ) \qquad ( 2 )$$

be the spectral measure of H associated with the initial state ρ. Then consider the convolution of p(x) and Θ(x), the 2π-periodic Heaviside function:

$$C ( x ) := ( Θ * p ) ( x ) = {\sum }_{j = 0}^{N - 1} {p}_{j} \cdot {1}_{x \geq {E}_{j}} ∀ x ∈ ( - π , π ) , \qquad ( 3 )$$

assuming that the eigenvalues of H are between (−π/3, π/3). Since p₀>0 and pⱼ≥0 for 1≤j<N−1, E₀ is the first non-zero point of C(x) for x∈(−π, π). Moreover, C(x) is non-decreasing in (−π, π). Thus, to evaluate the function C at different points, a natural approach is to use binary-search to find E₀. However, C(x) cannot be directly computed; however, can be estimated as follows:

C(x)=∫_{-∞}^{∞}\hat{Θ}(t)e^{2πixt}tr[ρe^{-2πiHt}]dt (4)

using a quantum computer. Here \hat{Θ}(t) is the Fourier coefficient of Θ(x). Note that tr [ρe^{-2πiHt}] can be estimated via the Hadamard-test circuit with evolution time 2πt. Thus, Equation 4 provides a way to estimate C(x). One issue is that the Fourier spectrum Θ(x) is unbounded, which means the Hamiltonian must be evolved for infinite time. One solution may be provided by designing a low Fourier-degree function F(x) that approximates Θ(x) in [−π+ϵ, −ϵ]∪[ϵ, π−ϵ]. The approximation of C(x) will then be:

$$\tilde{C} ( x ) := ( F * p ) ( x ) = {\sum }_{j = - d}^{d} \hat{F} ( j ) {e}^{2 π ijx} tr [ ρ {e}^{- 2 π iHj} ] .$$

It suffices to estimate 2d+1 terms to approximately evaluate \tilde{C}(x). It is proven that C(x)≈\tilde{C}(y) for some y that is ϵ-close to x. Therefore, the first non-zero point of C(x) can be approximated within ϵ-accuracy by a robust binary search on \tilde{C}(x).

Turning now to the problem of estimating the runtime costs of this algorithm, the maximal Hamiltonian evolution time (i.e., circuit depth) is proportional to the Fourier degree d of F(x). The Heaviside function Θ(x) is discontinuous at 0 and imposes challenges to approximating it by a low-Fourier-degree function or other low-degree smooth functions in a neighborhood of 0. The result may be obtained for an [symbol] (ϵ⁻¹)-Fourier degree function that approximates Θ(x) up to ϵ in [−π, π]\−ϵ, ϵ). Hence, the maximal evolution time of this approach is [symbol] (1/ϵ). As to the expected total evolution time, the multi-level Monte Carlo method was used to achieve Õ(ϵ⁻¹η⁻²)-time.

### Overcoming the 1/ϵ-Depth Barrier

The bottleneck of the maximal evolution time in previous methods is due to the high Fourier approximation degree of the Heaviside function. It is desirable choose another filter function that can still aid in estimating the minimum eigenvalue while having a lower Fourier approximate degree or band-limit. If the filter function satisfies the following properties, then it can isolate the minimum eigenvalue from the others, and the corresponding convolution can be evaluated easily:
1. The filter function f(x) has an exponentially-decaying tail, i.e., |f(x)|˜exp(−Ω(|x|)) for sufficiently large x. This enables the filter function to “almost” eliminate the interference of other eigenvalues to the peak around E₀.
2. The filter function's Fourier transform \hat{f}(t) has an exponentially-decaying tail, i.e., |\hat{f}(t) |˜exp(−Ω(|t|)) for sufficiently large t. This allows f to be approximated by a band-limited function.

This observation leads to a natural choice, the Gaussian filter, defined as:

$${f}_{σ} ( x ) = \frac{1}{\sqrt{2 π} σ} {e}^{- \frac{1}{2} {x}^{2} / {σ}^{2}} , \qquad ( 5 )$$

where σ>0 is a parameter to be chosen later. Note that its Fourier transform is another Gaussian kernel (up to some scaling factor):

$${\hat{f}}_{σ} ( t ) = {e}^{- \frac{1}{2} {( σπ t )}^{2}} .$$

Thus, most of its mass is concentrated within |t|= [symbol] (σ⁻¹). More importantly, by convolving f_{σ} with the spectral measure p, the result is:

$$( {f}_{σ} * p ) ( x ) = {\sum }_{j = 0}^{N - 1} {p}_{j} \cdot {f}_{σ} ( x - {E}_{j} ) ,$$

which is a mixture of Gaussians.

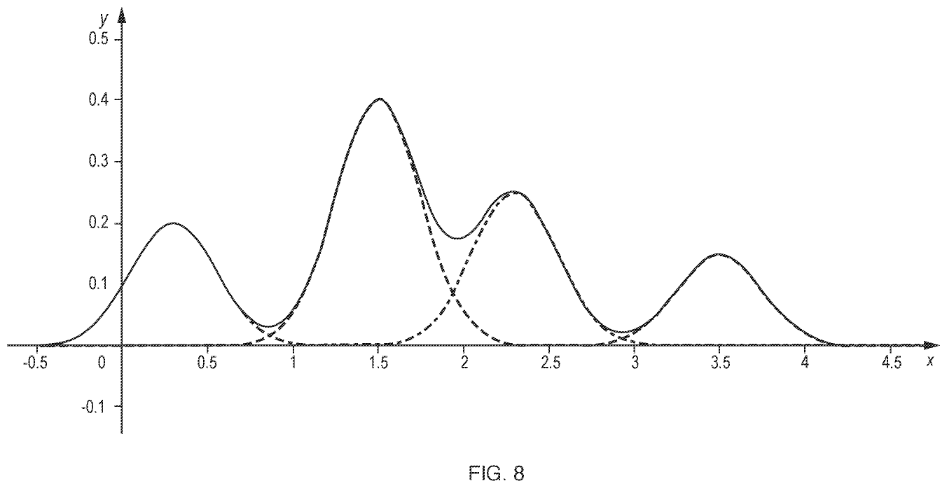

FIG. 8 illustrates an example of illustrates an example of f_{σ}*p. This figure illustrates the convolution (f_{σ}*p)(x)=Σⱼ₌₀³pⱼf_{σ}(x−Eⱼ) for σ=0.25, (p₀, p₁, p₂, p₃)=(0.2, 0.4, 0.25, 0.15) and (E₀, E₁, E₂, E₃)=(0. 3, 1. 5, 2.3, 3.5). The solid curve is (f_{σ}*p) (x) , while the dashed curves are pⱼf_{σ}(x−Eⱼ) for j=0, 1, 2, 3 respectively. Note that (f_{σ}*p)(x) resembles p₀f_{σ}(x−E₀) in a neighborhood of E₀=0.3.

The Gaussian filter has an exponentially-decaying tail. By focusing on the neighborhood around E₀, the convolution value is dominated by the first Gaussian kernel p₀·f_{σ}(x−E₀). Therefore, the first significant peak of f_{σ}*p will be close to E₀. And the GSEE is then reduced to a peak finding problem. One approach to solving this problem is to first run an algorithm with low accuracy (i.e., \tilde{E}₀∈[E₀− [symbol] (σ), E₀+ [symbol] (σ)]) and then partitioning the interval [\tilde{E}₀−σ, \tilde{E}₀+σ] into a O(ϵ)-width grid, followed by estimating the convolution f_{σ}*p at each grid point. Finally, the position of the grid point with maximum convolution value is output.

The complexity of this algorithm depends on σ, the width of the Gaussian filter, where this spectrum can only be truncated to [−T, T] for T=\tilde{Θ}(1/σ) in order to evaluate the convolution with enough precision. For a sufficiently small accuracy-parameter ϵ, taking σ= [symbol] (Δ/polylog(ϵ⁻¹η⁻¹)) ensures that the algorithm can output an estimate for E₀ within ϵ-additive error. This implies that the maximal Hamiltonian evolution time of the disclose algorithm is Õ(1/Δ).

When ϵ<<Δ, (the high-accuracy regime), the disclosed algorithm has lower quantum circuit depth than previous methods.

### A Universal Approach for the Convolution Evaluation

It remains to design a sample-efficient method to evaluate the convolution f_{σ,T}*p, where

f_{σ,T}(x):=∫_{-T}^{T}\hat{f}_{σ}(t)e^{2πixt}dt

is the band-limited approximation of f_{σ}. The general approach proposed in the disclosed technology evaluates such convolution for a large family of filter functions, which may be of independent interest. Let f_{T} be any function such that supp(\hat{f}_{T})⊆[−T, T] and \hat{f}_{T} is either continuous or a weighted sum of Dirac delta functions. Recall that

(f_{T}*p)(x)=∫_{-T}^{T}(t)e^{2πitx}tr[ρe^{-2πiHt}]dt.

The key idea for estimating this integral is to sample t∈[−T, T] from a distribution with the following probability density:

$$v ( t ) := \frac{\vert {\hat{f}}_{T} ( t ) \vert}{{‖ {\hat{f}}_{T} ‖}_{1}} , ∀ t ∈ [ - T , T ] ,$$

where ∥\hat{f}_{T}∥₁ is the L₁-norm of \hat{f}_{T}. A change of variables results is

(fₜ*p)(x)∫_{-T}^{T}∥\hat{f}_{T}∥₁e^{2πi(tx+ϕ(t))}tr[ρe^{-2πiHt}]v(t)dt,

where ϕ(t) is the phase of \hat{f}_{T}(t). Then, for S independent samples t₁, . . . , t_{S}˜v, the estimator for (f_{T}*p)(x) is defined as:

$$\overline{Z} ( x ) := \frac{{‖ {\hat{f}}_{T} ‖}_{1}}{S} {\sum }_{i = 1}^{S} {e}^{2 π i ( {t}_{i} x + ϕ ( {t}_{i} ) )} {Z}_{{t}_{i}} ,$$

where Zₜ_{ᵢ} is an estimate for tr[ρe^{-2πiHt}] obtained by running the Hadamard-test circuit twice (one for the real part and another for the imaginary part). To upper bound the sample complexity S, it is observed that |e^{2πi(t}^{ᵢ}^{x+ϕ(t}^{ᵢ}⁾⁾Zₜ_{ᵢ}|= [symbol] (1). Thus, by Hoeffding's bound, it suffices to take S= [symbol] (ϵ₁⁻²∥\hat{f}_{T}∥₁²) to achieve ϵ₁-accuracy.

The total evolution time of the algorithm with the Gaussian filter can be roughly bounded as follows. For the truncated Gaussian filter f_{σ,T}, μ\hat{f}_{σ,T}∥₁= [symbol] (σ⁻¹), and the convolution needs to be evaluated with accuracy ϵ₁= [symbol] (ηϵ²σ⁻³). Note that the Taylor expansion for the Gaussian density around 0 up to second order yields

$${f}_{σ} ( ϵ ) ≃ \frac{1}{\sqrt{2 π} σ} - \frac{{ϵ}^{2}}{\sqrt{2 π} {σ}^{3}} ,$$

and the peak will decrease by a factor of [symbol] (ηϵ²σ⁻³) around the ground state. Thus, by the choice of σ= [symbol] (Δ), the sample complexity is [symbol] (η⁻²ϵ⁻⁴σ⁻⁶·σ⁻²)= [symbol] (η⁻²ϵ⁻⁴Δ⁴). Hence, the total evolution time is [symbol] ₜₒₜ≤ [symbol] (η⁻²ϵ⁻⁴Δ⁴·T)= [symbol] (η⁻²ϵ⁻⁴Δ³) as T= [symbol] (1/σ)= [symbol] (1/Δ).

### Reducing ₜₒₜ via Gaussian Derivative Filtering

The bottleneck of the total evolution time is the normalized convolution evaluation accuracy

$$\frac{{ϵ}_{1}}{{‖ {\hat{f}}_{T} ‖}_{1}} ,$$

which equals to [symbol] (ηn²σ⁻²) or the Gaussian filter f_{σ}.

This factor is improved by switching to the Gaussian derivative filter g_{σ} which is defined as follows:

$${g}_{σ} ( x ) := - \frac{1}{\sqrt{2 π} {σ}^{3}} {xe}^{- \frac{{x}^{2}}{2 {σ}^{2}}} .$$

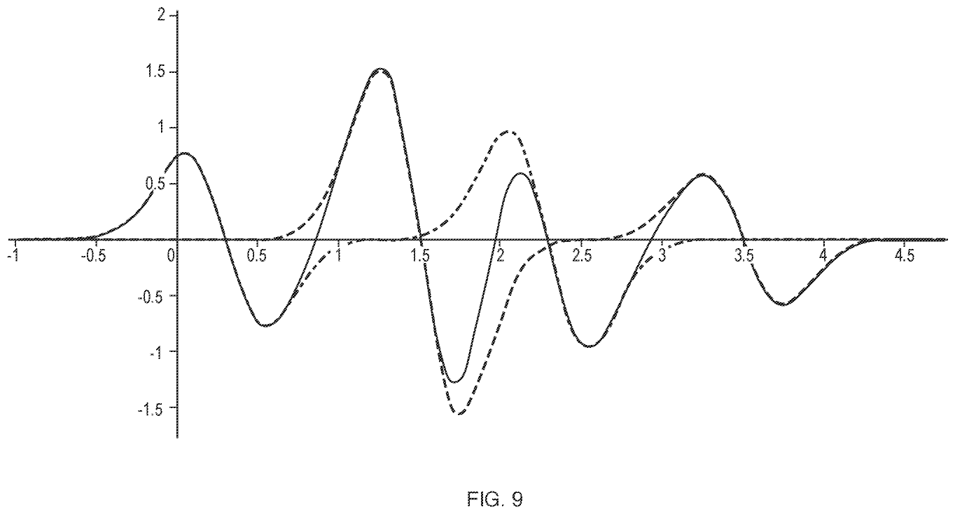

FIG. 9 illustrates an example of g_{σ}*p. Since the Gaussian derivative filter has an exponentially-decaying tail, (g_{σ}*p)(x) resembles p₀g_{σ}(x−E₀) in a neighborhood of E₀. In particular, the unique zero point of g₉₄*p in this region is close to E₀. FIG. 9 illustrates the convolution (g_{σ}*p)(x)=Σⱼ₌₀³pⱼg_{σ}(x−Eⱼ) for σ=0.25, (p₀, p₂, p₃)=(0.2,0.4,0.25,0.15) and (E₀, E₁, E₂, E₃)=(0.3,1.5,2.3,3.5). The solid curve is (g_{σ}*p)(x), while the dashed curves are pⱼg_{σ}(x−Eⱼ) for j=0, 1, 2, 3 respectively. Note that (g_{σ}*p)(x) resembles p₀g_{σ}(x−E₀) in a neighborhood of E₀=0.3. p₀g_{σ}(x−E₀).

A Gaussian derivative filter allows for a more favorable normalized convolution evaluation accuracy. On the one hand, the separation between the absolute values of the convolution (g_{σ}*p)(x) for x that is ϵ/2-close to E₀ and for x that is ϵ-far from E₀ is Ω(ηϵσ⁻³). So it suffices to pick ϵ₁′:= [symbol] (ηϵσ⁻³). On the other hand, it is easy to show that μĝ_{σ,T}μ₁=Θ(σ⁻²). This implies that the required normalized convolution evaluation accuracy for g_{σ} is

$$\frac{{{ϵ}_{1}}^{′}}{{‖ {\hat{g}}_{σ , T} ‖}_{1}} = 𝒪 ( {ηϵσ}^{- 1} ) .$$

Moreover, the present GSEE and convolution evaluation approaches are general so that they can be easily adapted to the Gaussian derivative filter function with almost the same parameters (i.e., σ= [symbol] (Δ) and T= [symbol] (1/σ). Therefore, using g_{σ} in the disclosed algorithm, the maximal evolution time remains to be [symbol] ₘₐₓ= [symbol] (Δ⁻¹) and the total evolution time is reduced [symbol] ₜₒₜ= [symbol] (η⁻²⊖⁻²Δ).

### Estimating Ground State Energy via Gaussian Derivative Filtering

In this section, a strategy is disclosed for GSEE based on Gaussian derivative filtering. The Gaussian derivative function was defined earlier, and a desirable property of the convolution between this filter and the spectral measure p will be proved. This property leads to a strategy for GSEE. Further on, it is shown that the Gaussian derivative function can be approximated by a band-limited function, which is crucial for efficient evaluation of the convolution.

1. Convolving the Spectral Measure with A Gaussian Derivative Filter
First, the Gaussian derivative function is defined and its properties are demonstrated.
Specifically, let σ>0 be arbitrary, and let

$${f}_{σ} ( x ) = \frac{1}{\sqrt{2 π} σ} {e}^{- \frac{{x}^{2}}{2 {σ}^{2}}}$$

be a Gaussian function. The Fourier transform of f_{σ} is

$${\hat{f}}_{σ} ( ξ ) = {e}^{- \frac{1}{2} {( σπξ )}^{2}} . \qquad ( 6 )$$

Now consider the derivative of f_{σ}, i.e.,

$${g}_{σ} ( x ) {{f}^{′}}_{σ} ( x ) = - \frac{1}{\sqrt{2 π} {σ}^{3}} {xe}^{- \frac{{x}^{2}}{2 {σ}^{2}}} . \qquad ( 7 )$$

Then the Fourier transform of g_{σ} is

$${\hat{g}}_{σ} ( ξ ) = 2 π i ξ {\hat{f}}_{σ} ( ξ ) = 2 π i ξ {e}^{- \frac{1}{2} {( σπξ )}^{2}} . \qquad ( 8 )$$

The following properties of g_{σ} and ĝ_{σ} will be useful:

### Fact 1. Properties of the Gaussian Derivative Function

1. g_{σ}(0)=0.
2. |g_{σ}(x)| is even, increases monotonically in (−∞, −σ]∪[0, σ], and decreases monotonically in [−σ, 0]Å[σ, ∞).
3. g_{σ}(x) decays exponentially to 0 as x→±∞.
4. ĝ_{σ}(ξ) decays exponentially to 0 as ξ→±∞.
   Now, consider the convolution between the filter g_{σ} and the spectral measure p:

$$( {g}_{σ} * p ) ( x ) = {\sum }_{j = 0}^{N - 1} {p}_{j} {g}_{σ} ( x - {E}_{j} ) = - \frac{1}{\sqrt{2 π} {σ}^{3}} {\sum }_{j = 0}^{N - 1} {p}_{j} ( x - {E}_{j} ) {xe}^{- \frac{{( x - {E}_{j} )}^{2}}{2 {σ}^{2}}} . \qquad ( 9 )$$

If σ is appropriately chosen, then |(g_{σ}*p)(x)| is small only if x is close to E₀, assuming x is at most O(σ)-away from E₀:
Lemma 2. Let c=\sqrt{2 ln(10/9)}≈0.45904, and let Δ and η be as in the problem formulation. Suppose ⊖>0 is small enough such that ϵ≤c·min

$$( \frac{0.9 Δ}{\sqrt{2 ln ( 9 {Δϵ}^{- 1} {η}^{- 1} )}} , 0.2 Δ ) .$$

### Then for

$$σ := min ( \frac{0.9 Δ}{\sqrt{2 ln ( 9 {Δϵ}^{- 1} {η}^{- 1} )}} , 0.2 Δ ) , \qquad ( 10 )$$

The following is true

$$\cdot \vert ( {g}_{σ} * p ) ( x ) \vert < \frac{0.6 ϵ {p}_{0}}{\sqrt{2 π} {σ}^{3}} , ∀ x ∈ [ {E}_{0} - 0.5 ϵ , {E}_{0} + 0.5 ϵ ] .$$

$$\cdot \vert ( {g}_{σ} * p ) ( x ) \vert > \frac{0.8 ϵ {p}_{0}}{\sqrt{2 π} {σ}^{3}} , ∀ x ∈ [ {E}_{0} - 0.5 σ , {E}_{0} - ϵ ) ⋃ ( {E}_{0} + ϵ , {E}_{0} + 0.5 σ ] .$$

Proof. Note that the choice of σ and the condition on ϵ imply that ϵ≤cσ<0.5σ. As a consequence, E₀−0.5σ<E₀−ϵ and E₀+ϵ<E₀+0.5σ. Thus, the interval in the second bullet is well-defined. Moreover, it follows from Eq. (10) that

$$\vert {g}_{σ} ( 0.9 Δ ) \vert = \frac{1}{\sqrt{2 π} {σ}^{3}} 0.9 Δ {e}^{- \frac{0.81 {Δ}^{2}}{2 {σ}^{2}}} \leq \frac{1}{\sqrt{2 π} {σ}^{3}} 0.1 ϵη \leq \frac{1}{\sqrt{2 π} {σ}^{3}} 0.1 ϵ {p}_{0} , \qquad ( 11 )$$

where the last step follows from p₀≥η.
The first and second parts of the Lemma are proven below.

### Part I.

For any x∈[E₀−0.5ϵ, E₀+0.5ϵ],

$$\vert ( {g}_{σ} * p ) ( x ) \vert = \vert {p}_{0} {g}_{σ} ( x - {E}_{0} ) + {\sum }_{j = 1}^{N - 1} {p}_{j} {g}_{σ} ( x - {E}_{j} ) \vert \leq {p}_{0} \vert {g}_{σ} ( x - {E}_{0} ) \vert + {\sum }_{j = 1}^{N - 1} {p}_{j} \vert {g}_{σ} ( x - {E}_{j} ) \vert \leq {p}_{0} \vert {g}_{σ} ( x - {E}_{0} ) \vert + {max}_{1 \leq j \leq N - 1} \vert {g}_{σ} ( x - {E}_{j} ) \vert . \qquad ( 13 )$$

The first term in Eq. (13) can be bounded as follows:

$$\vert {g}_{σ} ( x - {E}_{0} ) \vert \leq \vert {g}_{σ} ( 0.5 ϵ ) \vert = \frac{1}{\sqrt{2 π} {σ}^{3}} 0.5 ϵ {e}^{- \frac{0.25 {ϵ}^{2}}{2 {σ}^{2}}} \leq \frac{1}{\sqrt{2 π} {σ}^{3}} 0.5 ϵ . \qquad ( 16 )$$

To upper bound the second term in Eq. (13), first note that for each j≥1,

|x−Eⱼ|≥Eⱼ−E₀−0.5ϵ≥Δ−0.5ϵ<0.9Δ<σ,

where the last step follows from the property σ<0.2Δ in Eq. (10). The following is obtained

$$\vert {g}_{σ} ( x - {E}_{j} ) \vert < \vert {g}_{σ} ( 0.9 Δ ) \vert \leq \frac{1}{\sqrt{2 π} {σ}^{3}} 0.1 ϵ {p}_{0} , \qquad ( 22 )$$

where the second step follows from Eq. (11).
Combining Eqs. (13), (16), and (22), yields for x∈[E₀−0.5ϵ, E₀+0.5ϵ],

$$\vert ( {g}_{σ} * p ) ( x ) \vert < {p}_{0} \cdot \frac{1}{\sqrt{2 π} {σ}^{3}} 0.5 ϵ + \frac{1}{\sqrt{2 π} {σ}^{3}} 0.1 ϵ {p}_{0} = \frac{0.6 ϵ {p}_{0}}{\sqrt{2 π} {σ}^{3}} . \qquad ( 23 )$$

### Part II.

For any x∈[E₀−0.5σ, E₀−ϵ)∪(E₀+ϵ, E₀+0.5σ],

$$\vert ( {g}_{σ} * p ) ( x ) \vert = \vert {p}_{0} {g}_{σ} ( x - {E}_{0} ) + {\sum }_{j = 1}^{N - 1} {p}_{j} {g}_{σ} ( x - {E}_{j} ) \vert \geq {p}_{0} \vert {g}_{σ} ( x - {E}_{0} ) \vert - {\sum }_{j = 1}^{N - 1} {p}_{j} \vert {g}_{σ} ( x - {E}_{j} ) \vert \geq {p}_{0} \vert {g}_{σ} ( x - {E}_{0} ) \vert - {max}_{1 \leq j \leq N - 1} \vert {g}_{σ} ( x - {E}_{j} ) \vert . \qquad ( 25 )$$

The first term in Eq. (25) can be lower bounded as follows:

$$\vert {g}_{σ} ( x - {E}_{0} ) \vert > \vert {g}_{σ} ( ϵ ) \vert = \frac{1}{\sqrt{2 π} {σ}^{3}} ϵ {e}^{- \frac{{ϵ}^{2}}{2 {σ}^{2}}} \geq \frac{1}{\sqrt{2 π} {σ}^{3}} ϵ {e}^{- \frac{{c}^{2}}{2}} \geq \frac{1}{\sqrt{2 π} {σ}^{3}} 0.9 ϵ , \qquad ( 29 )$$

where the last step follows from c=\sqrt{2 ln(10/9)}.
To upper bound the second term in Eq. (25), note that for each j>1,

|x−Eⱼ|≥Eⱼ−E₀−0.5σ≥Δ−0.5σ<0.9Δ<σ,

where the last two inequalities follow from the property σ<0.2Δ in Eq. (10).
Then, the following is obtained:

$$\vert {g}_{σ} ( x - {E}_{j} ) \vert \leq \vert {g}_{σ} ( 0.9 Δ ) \vert \leq \frac{1}{\sqrt{2 π} {σ}^{3}} 0.1 ϵ {p}_{0} , \qquad ( 34 )$$

where the last step follows from Eq. (11).
Combining Eqs. (25), (29), and (34), yields for x∈[E₀−0.5σ, E₀−ϵ)∪(E₀+ϵ, E₀+0.5σ],

$$\vert ( {g}_{σ} * p ) ( x ) \vert > {p}_{0} \cdot \frac{1}{\sqrt{2 π} {σ}^{3}} 0.9 ϵ - \frac{1}{\sqrt{2 π} {σ}^{3}} 0.1 ϵ {p}_{0} = \frac{0.8 ϵ {p}_{0}}{\sqrt{2 π} {σ}^{3}} . \qquad ( 35 )$$

The lemma is thus proved.

### 2. Basic Strategy For Ground State Energy Estimation

Lemma 2 is used to develop the following strategy for estimating ground state energy. An estimate \tilde{E}₀ of E₀ is first obtained such that \tilde{E}₀ is O(σ)-close to E₀ with high probability. Then a point is determined at which |(g_{σ}*p)| has small value in a region [\tilde{E}₀−O(σ), \tilde{E}₀+O(σ)]. Using Lemma 2, it can be proven that this point is c-close to E₀ with high probability.

Lemma 3. Let Δ, η, ϵ and δ be as in the problem formulation. Suppose ϵ satisfies the condition in Lemma 2. Let σ be defined as Eq. (10). Suppose \tilde{E}₀ is a random variable such that

$$ℙ [ \vert {\tilde{E}}_{0} - {E}_{0} \vert > \frac{σ}{4} ] < \frac{δ}{2} . \qquad ( 36 )$$

Let M:=[σ/ϵ]+1, and let xⱼ:=\tilde{E}₀−0.25σ+(0.5σ/M)·(j−1) for j∈[M]. Suppose h₁, h₂, . . . , h_{M} are random variables such that

$$ℙ [ ∀ j ∈ [ M ] : \vert ( {g}_{σ} * p ) ( {x}_{j} ) - {h}_{j} \vert \leq \frac{0.1 ϵ η}{\sqrt{2 π} {σ}^{3}} \geq 1 - \frac{δ}{2} . \qquad ( 37 )$$

### Let

$${j}^{*} = arg {min}_{1 \leq j \leq M} \vert {h}_{j} \vert .$$

### Then

[symbol] [|x_{j*}−E₀|>ϵ]<δ (38)

Proof. By the assumptions about [symbol] and h₁, h₂, . . . , h_{M} and the union bound, the following events happen simultaneously with probability at least 1−δ:

$$\vert {\tilde{E}}_{0} - {E}_{0} \vert \leq 0.25 σ .$$

$$\vert ( {g}_{0} * p ) ( {x}_{j} ) - {h}_{j} \vert \leq \frac{0.1 ϵ η}{\sqrt{2 π} {σ}^{3}} , ∀ j ∈ [ M ] .$$

In this case, x₀, x₁, . . . , x_{M}∈[ [symbol] −0.25σ, \tilde{E}₀+0.25σ]⊆[E₀−0.5σ, E₀+0.5σ]. Then by Lemma [symbol] 2, it is shown that
If |xⱼ−E₀|≤0.5ϵ, then

$$\vert {h}_{j} \vert \leq \vert ( {g}_{σ} * p ) ( {x}_{j} ) \vert + \vert ( {g}_{σ} * p ) ( {x}_{j} ) - {h}_{j} \vert < \frac{0.6 ϵ {p}_{0}}{\sqrt{2 π} {σ}^{3}} + \frac{0.1 ϵ η}{\sqrt{2 π} {σ}^{3}} \leq \frac{0.7 ϵ {p}_{0}}{\sqrt{2 π} {σ}^{3}} . \qquad ( 39 )$$

If |xⱼ−E₀|>ϵ, then

$$\vert {h}_{j} \vert \geq \vert ( {g}_{σ} * p ) ( {x}_{j} ) \vert + \vert ( {g}_{σ} * p ) ( {x}_{j} ) - {h}_{j} \vert < \frac{0.8 ϵ {p}_{0}}{\sqrt{2 π} {σ}^{3}} - \frac{0.1 ϵ η}{\sqrt{2 π} {σ}^{3}} \geq \frac{0.7 ϵ {p}_{0}}{\sqrt{2 π} {σ}^{3}} . \qquad ( 40 )$$

Meanwhile, note that x₁≤E₀≤x_{M}, and |xⱼ₊₁−xⱼ|≤0.5ϵ, ∀j∈[M−1]. So there exists some j₀∈[M] such that |xⱼ_{₀}−E₀|0.5≤ϵ. This implies

$$\vert {h}_{{j}^{*}} \vert \leq \vert {h}_{{j}_{0}} \vert < \frac{0.7 ϵ {p}_{0}}{t 2 π {σ}^{3}} ,$$

which in turn implies that |x_{j*}−E₀|≤ϵ. This lemma is thus proved. □

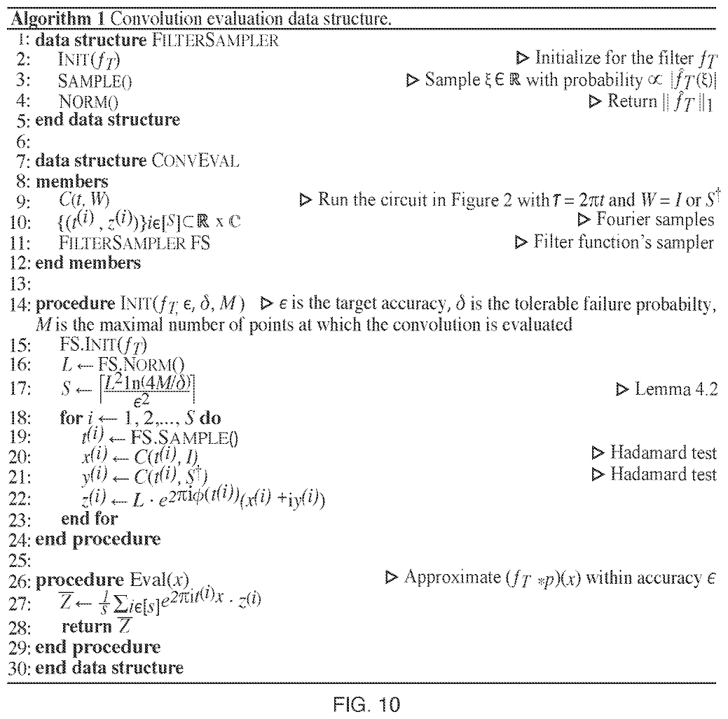

It remains to show how to generate the random variables \tilde{E}₀ and h₁, h₂, . . . , h_{M} that satisfy the conditions Eqs. (36) and (37) respectively. To obtain \tilde{E}₀, a GSEE algorithm is used which takes Õ(ϵ⁻¹) maximal Hamiltonian evolution time to achieve ϵ-accuracy. Since \tilde{E}₀ only needs σ/4 accuracy, this step has Õ(σ⁻¹) maximal evolution time. To obtain h₁, h₂, . . . , h_{M}, the band-limited version of g_{σ}, denoted as g_{σ,T}, is introduced such that (g_{σ}*p)(x)≈(g_{σ,T}*p)(x) for a small T. A data structure ConvEval has been designed such that this data structure can evaluate g_{σ,T}*p at the points x₀, x₁, . . . , x_{M} with high accuracy and confidence after appropriate initialization. This data structure is illustrated in FIG. 10, in pseudocode form.

### 3. Gaussian Derivative Filters With Bounded Band-Limits

In order to efficiently evaluate g_{σ}*p at any given point, the spectrum of g_{σ} is truncated and T-bandlimit version g_{σ} is constructed such that

(g_{σ}*p)(x)≈(g_{σ,T}*p)(x), ∀x∈ [symbol] (41)

Specifically, g_{σ,T}, is defined by restricting ĝ_{σ} to [−T, T] and performing the inverse Fourier transform:

g_{σ,T}(x)∫_{-T}^{T}ĝ_{σ}(ξ)e^{2πixξ}dξ. (42)

Clearly, g_{σ,T}→g_{σ} as T→∞. The following lemma shows how to choose T such that g_{σ,T} can approximate g_{σ} in L_{∞}-norm:
Lemma 4. Let ϵ₁>0 be arbitrary. Then for

T:=π⁻¹σ⁻¹\sqrt{2 ln(8π⁻¹⊖₁⁻¹σ⁻²),} (43)

it is shown that

$$\vert {g}_{σ} ( x ) - {g}_{σ , T} ( x ) \vert \leq \frac{{ϵ}_{1}}{2} , ∀ x ∈ ℝ . \qquad ( 44 )$$

Proof. By the Fourier inversion theorem, it is shown that

$$\begin{matrix}\vert {g}_{σ} ( x ) - {g}_{σ , T} ( x ) \vert = \vert {\int }_{- ∞}^{- T} {\hat{g}}_{σ} ( ξ ) {e}^{2 π i ξ x} d ξ + {\int }_{T}^{+ ∞} {\hat{g}}_{σ} ( ξ ) {e}^{2 π i ξ x} d ξ \vert \geq \\ {\int }_{- ∞}^{- T} \vert {\hat{g}}_{σ} ( ξ ) d ξ + {\int }_{T}^{+ ∞} \vert {\hat{g}}_{σ} ( ξ ) \vert d ξ \\ = 2 {\int }_{T}^{+ ∞} 2 πξ {e}^{- \frac{1}{2} {( σ π ξ )}^{2}} d ξ \\ = \frac{4}{{σ}^{2} π} {e}^{- \frac{1}{2} {σ}^{2} {π}^{2} {T}^{2}} .\end{matrix} \qquad ( 45 )$$

By solving the inequality

$$\frac{4}{{σ}^{2} π} {e}^{- \frac{1}{2} {σ}^{2} {π}^{2} {T}^{2}} \leq \frac{{ϵ}_{1}}{2} , \qquad ( 46 )$$

it suffices to take

T≥π⁻¹σ⁻¹\sqrt{2 ln(8π⁻¹⊖₁⁻¹σ⁻²).} (47)

□
The following Claim A shows that the L_{∞}-approximation for g_{σ}implies the L_{∞}-approximation for g_{σ}*p.
Claim A. Let T be defined as in Lemma 4. Then

$$\vert ( {g}_{σ} * p ) ( x ) - ( {g}_{σ , T} * p ) ( x ) \vert \leq \frac{{ϵ}_{1}}{2} , ∀ x ∈ ℝ .$$

Proof. For any x∈ [symbol] , it is shown that

$$\begin{matrix}\vert ( {g}_{σ} * p ) ( x ) - ( {g}_{σ , T} * p ) ( x ) \vert = \vert {\int }_{- ∞}^{∞} ( {g}_{σ} ( z ) - {g}_{σ , T} ( z ) ) p ( x - z ) dz \vert \leq \\ {\int }_{- ∞}^{∞} \vert {g}_{σ} ( z ) - {g}_{σ , T} ( z ) \vert p ( x - z ) dz \leq \\ \frac{{ϵ}_{1}}{2} {\int }_{- ∞}^{∞} p ( x - z ) dz \\ = \frac{{ϵ}_{1}}{2} ,\end{matrix} \qquad ( 48 )$$

where the first step follows from the definition of convolution, the section step follows from the triangle inequality, the third step follows from Lemma 4, and the last step follows from the property of Dirac delta function. Claim A implies that in order to estimate (g_{σ}*p)(x) within ϵ₁-accuracy, it suffices to evaluate (g_{σ,T}*p)(x) within 0.5⊖₁-accuracy, which can be achieved by the method below.

### Complexity of Evaluating the Convolution

This section focuses on evaluating the convolution between a filter function f and the spectral measure p to within ϵ-additive error. In Section 1, an evaluation method is disclosed for general filter functions with bounded band-limits. In Section 2, the method is applied to the Gaussian derivative filter used in the GSEE algorithm.

### 1. Evaluating the Convolution Via Hadamard Tests

In general, the method is not restricted to a specific filter f but consider arbitrary filters with bounded band-limits. Specifically, for a parameter T>0, let f_{T} be a function with band-limit T, i.e.,

f_{T}(x)=∫₋ₜ^{T}\hat{f}ₜ)(t)e^{2πitx}dt, (49)

where \hat{f}_{T} is the Fourier transform of f_{T} and satisfies \hat{f}_{T}(t)=0 for all t∈(−∞, −T)∪(T, +∞). Furthermore, \hat{f}_{T} is required to be either continuous in [−T, T] or a weighted sum of Dirac delta functions (i.e., f_{T} has a discrete spectrum). Results are stated for the former case, which can easily be generalized to the latter case.
Given such a function \hat{f}_{T}, A probability density v can be defined in terms of its Fourier weights:

$$v ( t ) = \frac{\vert {\hat{f}}_{T} ( t ) \vert}{{‖ {f}_{T} ‖}_{1}} , ∀ t ∈ [ - T , T ] . \qquad ( 50 )$$

Moreover, let ϕ(t) be the phase of \hat{f}_{T}(t), i.e., \hat{f}_{T}(t)=|\hat{f}_{T}(t)|e^{i2πϕ(t)}.
It follows that

f_{T}(x)=∫_{-T}^{T}∥\hat{f}_{T}μ₁e^{2πi(tx+ϕ(t))}v(t)dt (51)

Given a quantum state ρ, a Hamiltonian H and a parameter t∈[−T, T], two random variables Xₜ and Yₜ are defined as follows. Let b_{I} and b_{S†} be the measurement outcome of the circuit in FIG. 7 with τ=2πt and W=I or S† (where S is the phase gate), respectively. Then Xₜ=(−1)^{b}^{_{I}} and Yₜ=(−1)^{b}^{_{S\}}satisfy:

[symbol]

[Xₜ]=Re(tr[ρe^{-2πiHt}]) , [symbol] [Yₜ]=Im(tr[ρe^{-2πiHt}]). (52)

Given a point x∈ [symbol] , the random variable Z(x) is defined as follows. Let t be a random variable with probability density function v.

Z(x)∥\hat{f}_{T}∥₁·e^{2πi(tx+ϕ(t))}·(Xₜ+iYₜ). (53)

In the above equation, Z(x) is an unbiased estimator of the convolution f_{T}*p at point x:

Lemma 1. For the random variable Z(x) defined as Eq. (53), it follows that

[symbol]

[Z(x)]=(f_{T}*p)(x), ∀x∈ [symbol] . (54)

Proof. First consider the conditional expectation [symbol] [Z(x)|t=t] for some t∈[−T, T]. By Eq. (52) and the definition of Z(x) in Eq. (53):

$$\begin{matrix}𝔼 [ Z ( x ) ] = {\int }_{- T}^{T} 𝔼 [ Z ( x ) \vert t = t ] \cdot ℙ [ t = t ] dt \\ = {\int }_{- T}^{T} {‖ {\hat{f}}_{T} ‖}_{1} {e}^{2 π i ( tx + ϕ ( t ) )} tr [ ρ {e}^{- 2 π iHt} ] .\end{matrix} \qquad ( 55 )$$

By the law of total expectation:

$$\begin{matrix}𝔼 [ Z ( x ) ] = {\int }_{- T}^{T} 𝔼 [ Z ( x ) \vert t = t ] \cdot ℙ [ t = t ] dt \\ = {\int }_{- T}^{T} {‖ {\hat{f}}_{T} ‖}_{1} {e}^{2 π i ( tx + ϕ ( t ) )} tr [ ρ {e}^{- 2 π iHt} ] v ( t ) dt \\ = {\int }_{- T}^{T} {\hat{f}}_{T} ( t ) {e}^{2 π itx} tr [ ρ {e}^{- 2 π iHt} ] dt ,\end{matrix} \qquad ( 56 )$$

where the last step follows from the definition of v in Eq. (50) and the definition of ϕ(t).
It remains to prove that the above expression indeed coincides with f_{T}*p(x):

$$\begin{matrix}( {f}_{T} * p ) ( x ) = {\int }_{- ∞}^{∞} p ( x - y ) {f}_{T} ( y ) dy \\ = {\int }_{- ∞}^{∞} {\int }_{- T}^{T} p ( x - y ) {\hat{f}}_{T} ( t ) {e}^{2 π ity} dtdy \\ = {\int }_{- T}^{T} {\hat{f}}_{T} ( t ) dt {\int }_{- ∞}^{∞} p ( x - y ) {e}^{2 π ity} dy .\end{matrix} \qquad ( 57 )$$

By the definition of p(x) in Eq. (2):

$$\begin{matrix}{\int }_{- ∞}^{∞} p ( x - y ) {e}^{2 π ity} dy = {\int }_{- ∞}^{∞} {\sum }_{k \geq 0} {p}_{k} δ ( x - y - {E}_{k} ) {e}^{2 π ity} dy \\ = {\sum }_{k \geq 0} {p}_{k} {e}^{2 π it ( x - {E}_{k} )} ,\end{matrix} \qquad ( 58 )$$

where the last step follows from the integration of Dirac delta function. Then, it implies that

$$\begin{matrix}( {f}_{T} * p ) ( x ) = {\int }_{- T}^{T} {\hat{f}}_{T} ( t ) dt \cdot {\sum }_{k \geq 0} {p}_{k} {e}^{2 π it ( x - {E}_{k} )} \\ = {\int }_{- T}^{T} {\hat{f}}_{T} ( t ) {e}^{2 π itx} tr [ ρ {e}^{- 2 π iHt} ] dt ,\end{matrix} \qquad ( 59 )$$

where the last step follows from tr[ρe^{-2πiHt}]=Σ_{k≥0}pₖe^{-2πiE}^{ₖ}.
Comparing Eqs. (56) and (59), it is concluded that [symbol] [Z(x)]=(f_{T}*p)(x) for all x∈ [symbol] . The lemma is thus proved.

With Lemma 1 established, it is now straightforward to analyze how many samples are needed to estimate the function f_{T}*p at various points within a target accuracy.

Lemma 2. (Sample complexity of the convolution evaluation) Let {(t⁽ⁱ⁾, X⁽ⁱ⁾, Y⁽ⁱ⁾)}ᵢ₋₁^{S} be S i.i.d. samples such that t⁽ⁱ⁾˜v, X⁽ⁱ⁾˜Xₜ_{ᵢ} and Y⁽ⁱ⁾˜Yₜ_{ᵢ}, where v is defined as Eq. (50), and Xₜ and Yₜ are the measurement outcome of the Hadamard test with τ=2πt and W=I or S, respectively. Let x₁, x₂, . . . , x_{M}∈ [symbol] be arbitrary. For each j∈[M], let Z̅ⱼ be defined as follows:

$$\overline{{Z}_{j}} := \frac{{‖ {\hat{f}}_{T} ‖}_{1}}{S} {\sum }_{i = 1}^{S} {e}^{2 π i ( {t}^{( i )} {x}_{j} + ϕ ( {t}^{( i )} ) )} \cdot ( {X}^{( i )} + {iY}^{( i )} ) . \qquad ( 60 )$$

Then for any ϵ₁>0 and δ₁∈(0,1), letting

$$S := ⌈ \frac{{‖ {\hat{f}}_{T} ‖}_{1}^{2} ln ( 4 M / {δ}_{1} )}{{ϵ}_{1}^{2}} ⌉ . \qquad ( 61 )$$

it is shown that

[symbol]

[∀j∈[M]:|Z̅ⱼ−(f_{T}*p)(xⱼ)|≤ϵ₁]≥1−δ₁. (62)

Proof. Recall that Z(x)=∥\hat{f}_{T}∥₁·e^{2πi(tx+ϕ(t))}·(Xₜ+iYₜ) for any x∈ [symbol] . Then Z̅ⱼ is the empirical mean of S i.i.d. samples of Z(xⱼ) that correspond to {(t⁽ⁱ⁾, X⁽ⁱ⁾, Y⁽ⁱ⁾)}ᵢ₋₁^{S}, for each j∈[M]. Since Xₜ and Yₜ take values in {1, −1}, it is known that Re (Z(x)) and Im (Z(x)) take values in [−∥\hat{f}_{T}∥₁, ∥\hat{f}_{T}∥₁]. It then follows from Hoeffding's inequality for the choice of S in Eq. (61), for any j∈[M], it holds that

$$ℙ [ \vert Re ( \overline{{Z}_{j}} - 𝔼 [ Re ( Z ( {x}_{j} ) ) ] ] > \frac{{ϵ}_{1}}{\sqrt{2}} ] < \frac{{δ}_{1}}{2 M} , \qquad ( 63 )$$

$$ℙ [ \vert Im ( \overline{{Z}_{j}} - 𝔼 [ Im ( Z ( {x}_{j} ) ) ] ] > \frac{{ϵ}_{1}}{\sqrt{2}} ] < \frac{{δ}_{1}}{2 M} , \qquad ( 64 )$$

Then by the triangle inequality and union bound:

$$ℙ [ \vert \overline{{Z}_{j}} - 𝔼 [ ( Z ( {x}_{j} ) ) ] ] > {ϵ}_{1} ] < \frac{{δ}_{1}}{M} . \qquad ( 65 )$$

Meanwhile, by Lemma 1, it known that

[symbol]

[Z(xⱼ)]=(f_{T}*p)(xⱼ). (66)

### Thus,

$$ℙ [ \vert \overline{{Z}_{j}} - ( {f}_{T} * p ) ( {x}_{j} ) ] \vert > {ϵ}_{1} ] < \frac{{δ}_{1}}{M} . \qquad ( 67 )$$

By a union bound over all j∈[M],

[symbol]

[∃ⱼ∈[M]:|Z̅ⱼ−(f_{T}*p)(xⱼ)]|>ϵ₁]<δ₁. (68)

Remark 3. Note that in Lemma 2, Z̅ⱼ is a complex number in general, but (f_{T}*p)(xⱼ) is real provided that f_{T} is real. In this case, Z̅ⱼ can be redefined as the real part of the right-hand side of the prior equation.

FIG. 10 illustrates, in pseudocode, a data structure ConvEval for evaluating the convolution f_{T}*p at multiple points.

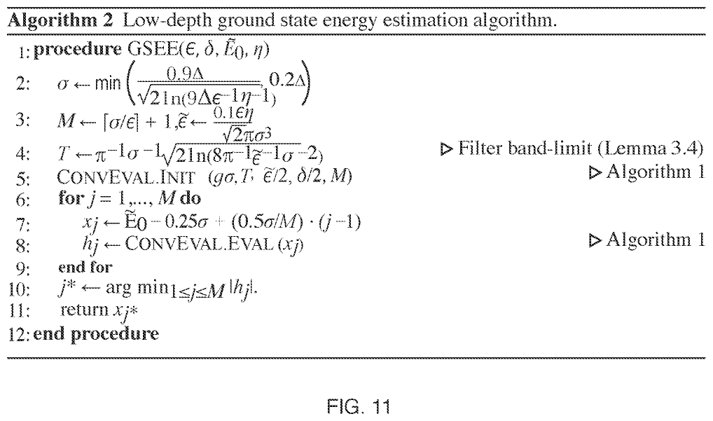

FIG. 11 illustrates, in pseudocode, a low-depth ground state energy estimation (GSEE) algorithm.

One embodiment is directed to a method, performed on a computer system, for estimating a ground state energy of a Hamiltonian that characterizes a physical system. The computer system includes a quantum computing component and a classical computing component. The quantum computing component includes a plurality of qubits. The classical computing component includes a classical processor and a non-transitory computer-readable memory. The non-transitory computer-readable memory stores computer instructions, which, when executed by the classical processor, perform the method. The method includes: causing the quantum computing component to derive outcome samples from a plurality of Hadamard tests in which a unitary is a time evolution of the Hamiltonian; on the classical computing component, evaluating a convolution of a spectral measure and a filter function from the outcome samples; and on the classical computing component, inferring an estimate of the ground state energy from the convolution.

The physical system may include a molecule and/or a physical material.

The quantum computing component may include a fault-tolerant quantum computer. The quantum computing component may include a low-depth quantum circuit having an initial overlap. The method may further include selecting a target accuracy for the estimate of the ground state energy. The Hamiltonian may have an inverse spectral gap of the Hamiltonian; the target accuracy may have an inverse of the target accuracy; and the initial overlap may have an inverse of the initial overlap. The low-depth quantum circuit may have a depth that is linear in the inverse spectral gap of the Hamiltonian and poly-logarithmic in the inverse of the target accuracy and the inverse of the initial overlap. A runtime of the method may be polynomial in the inverse spectral gap of the Hamiltonian, the inverse of the target accuracy, and the inverse of the initial overlap.

The method may further include inferring, from the estimate of the ground state energy, a property of the Hamiltonian.

Another embodiment is directed to a hybrid quantum-classical computer system for estimating a ground state energy of a Hamiltonian that characterizes a physical system. The hybrid quantum-classical computer system includes: a quantum computing component including a plurality of qubits; and a classical computing component including a classical processor and a non-transitory computer-readable memory. The non-transitory computer-readable memory may store computer instructions, which, when executed by the classical processor, perform a method. The method may include: causing the quantum computing component to derive outcome samples from a plurality of Hadamard tests in which a unitary is a time evolution of the Hamiltonian; on the classical computing component, evaluating a convolution of a spectral measure and a filter function from the outcome samples; and on the classical computing component, inferring an estimate of the ground state energy from the convolution.

The physical system may include a molecule and/or a physical material.

The quantum computing component may include a fault-tolerant quantum computer. The quantum computing component may include a low-depth quantum circuit having an initial overlap. The method may further include selecting a target accuracy for the estimate of the ground state energy. The Hamiltonian may have an inverse spectral gap of the Hamiltonian; the target accuracy may have an inverse of the target accuracy; and the initial overlap may have an inverse of the initial overlap. The low-depth quantum circuit may have a depth that is linear in the inverse spectral gap of the Hamiltonian and poly-logarithmic in the inverse of the target accuracy and the inverse of the initial overlap. A runtime of the method may be polynomial in the inverse spectral gap of the Hamiltonian, the inverse of the target accuracy, and the inverse of the initial overlap.

The method may further include inferring, from the estimate of the ground state energy, a property of the Hamiltonian.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Various physical embodiments of a quantum computer are suitable for use according to the present disclosure. In general, the fundamental data storage unit in quantum computing is the quantum bit, or qubit. The qubit is a quantum-computing analog of a classical digital computer system bit. A classical bit is considered to occupy, at any given point in time, one of two possible states corresponding to the binary digits (bits) 0 or 1. By contrast, a qubit is implemented in hardware by a physical medium with quantum-mechanical characteristics. Such a medium, which physically instantiates a qubit, may be referred to herein as a “physical instantiation of a qubit,” a “physical embodiment of a qubit,” a “medium embodying a qubit,” or similar terms, or simply as a “qubit,” for ease of explanation. It should be understood, therefore, that references herein to “qubits” within descriptions of embodiments of the present invention refer to physical media which embody qubits.

Each qubit has an infinite number of different potential quantum-mechanical states. When the state of a qubit is physically measured, the measurement produces one of two different basis states resolved from the state of the qubit. Thus, a single qubit can represent a one, a zero, or any quantum superposition of those two qubit states; a pair of qubits can be in any quantum superposition of 4 orthogonal basis states; and three qubits can be in any superposition of 8 orthogonal basis states. The function that defines the quantum-mechanical states of a qubit is known as its wavefunction. The wavefunction also specifies the probability distribution of outcomes for a given measurement. A qubit, which has a quantum state of dimension two (i.e., has two orthogonal basis states), may be generalized to a d-dimensional “qudit,” where d may be any integral value, such as 2, 3, 4, or higher. In the general case of a qudit, measurement of the qudit produces one of d different basis states resolved from the state of the qudit. Any reference herein to a qubit should be understood to refer more generally to an d-dimensional qudit with any value of d.

Although certain descriptions of qubits herein may describe such qubits in terms of their mathematical properties, each such qubit may be implemented in a physical medium in any of a variety of different ways. Examples of such physical media include superconducting material, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or aggregations of any of the foregoing that exhibit qubit behavior, that is, comprising quantum states and transitions therebetween that can be controllably induced or detected.

For any given medium that implements a qubit, any of a variety of properties of that medium may be chosen to implement the qubit. For example, if electrons are chosen to implement qubits, then the x component of its spin degree of freedom may be chosen as the property of such electrons to represent the states of such qubits. Alternatively, the y component, or the z component of the spin degree of freedom may be chosen as the property of such electrons to represent the state of such qubits. This is merely a specific example of the general feature that for any physical medium that is chosen to implement qubits, there may be multiple physical degrees of freedom (e.g., the x, y, and z components in the electron spin example) that may be chosen to represent 0 and 1. For any particular degree of freedom, the physical medium may controllably be put in a state of superposition, and measurements may then be taken in the chosen degree of freedom to obtain readouts of qubit values.

Certain implementations of quantum computers, referred to as gate model quantum computers, comprise quantum gates. In contrast to classical gates, there is an infinite number of possible single-qubit quantum gates that change the state vector of a qubit. Changing the state of a qubit state vector typically is referred to as a single-qubit rotation, and may also be referred to herein as a state change or a single-qubit quantum-gate operation. A rotation, state change, or single-qubit quantum-gate operation may be represented mathematically by a unitary 2×2 matrix with complex elements. A rotation corresponds to a rotation of a qubit state within its Hilbert space, which may be conceptualized as a rotation of the Bloch sphere. (As is well-known to those having ordinary skill in the art, the Bloch sphere is a geometrical representation of the space of pure states of a qubit.) Multi-qubit gates alter the quantum state of a set of qubits. For example, two-qubit gates rotate the state of two qubits as a rotation in the four-dimensional Hilbert space of the two qubits. (As is well-known to those having ordinary skill in the art, a Hilbert space is an abstract vector space possessing the structure of an inner product that allows length and angle to be measured. Furthermore, Hilbert spaces are complete: there are enough limits in the space to allow the techniques of calculus to be used.)

A quantum circuit may be specified as a sequence of quantum gates. As described in more detail below, the term “quantum gate,” as used herein, refers to the application of a gate control signal (defined below) to one or more qubits to cause those qubits to undergo certain physical transformations and thereby to implement a logical gate operation. To conceptualize a quantum circuit, the matrices corresponding to the component quantum gates may be multiplied together in the order specified by the gate sequence to produce a 2ⁿ×2ⁿ complex matrix representing the same overall state change on n qubits. A quantum circuit may thus be expressed as a single resultant operator. However, designing a quantum circuit in terms of constituent gates allows the design to conform to a standard set of gates, and thus enable greater ease of deployment. A quantum circuit thus corresponds to a design for actions taken upon the physical components of a quantum computer.

A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In certain embodiments of quantum circuits, the quantum circuit includes both one or more gates and one or more measurement operations. Quantum computers implemented using such quantum circuits are referred to herein as implementing “measurement feedback.” For example, a quantum computer implementing measurement feedback may execute the gates in a quantum circuit and then measure only a subset (i.e., fewer than all) of the qubits in the quantum computer, and then decide which gate(s) to execute next based on the outcome(s) of the measurement(s). In particular, the measurement(s) may indicate a degree of error in the gate operation(s), and the quantum computer may decide which gate(s) to execute next based on the degree of error. The quantum computer may then execute the gate(s) indicated by the decision. This process of executing gates, measuring a subset of the qubits, and then deciding which gate(s) to execute next may be repeated any number of times. Measurement feedback may be useful for performing quantum error correction, but is not limited to use in performing quantum error correction. For every quantum circuit, there is an error-corrected implementation of the circuit with or without measurement feedback.

Some embodiments described herein generate, measure, or utilize quantum states that approximate a target quantum state (e.g., a ground state of a Hamiltonian). As will be appreciated by those trained in the art, there are many ways to quantify how well a first quantum state “approximates” a second quantum state. In the following description, any concept or definition of approximation known in the art may be used without departing from the scope hereof. For example, when the first and second quantum states are represented as first and second vectors, respectively, the first quantum state approximates the second quantum state when an inner product between the first and second vectors (called the “fidelity” between the two quantum states) is greater than a predefined amount (typically labeled ϵ). In this example, the fidelity quantifies how “close” or “similar” the first and second quantum states are to each other. The fidelity represents a probability that a measurement of the first quantum state will give the same result as if the measurement were performed on the second quantum state. Proximity between quantum states can also be quantified with a distance measure, such as a Euclidean norm, a Hamming distance, or another type of norm known in the art. Proximity between quantum states can also be defined in computational terms. For example, the first quantum state approximates the second quantum state when a polynomial time-sampling of the first quantum state gives some desired information or property that it shares with the second quantum state.

Not all quantum computers are gate model quantum computers. Embodiments of the present invention are not limited to being implemented using gate model quantum computers. As an alternative example, embodiments of the present invention may be implemented, in whole or in part, using a quantum computer that is implemented using a quantum annealing architecture, which is an alternative to the gate model quantum computing architecture. More specifically, quantum annealing (QA) is a metaheuristic for finding the global minimum of a given objective function over a given set of candidate solutions (candidate states), by a process using quantum fluctuations.

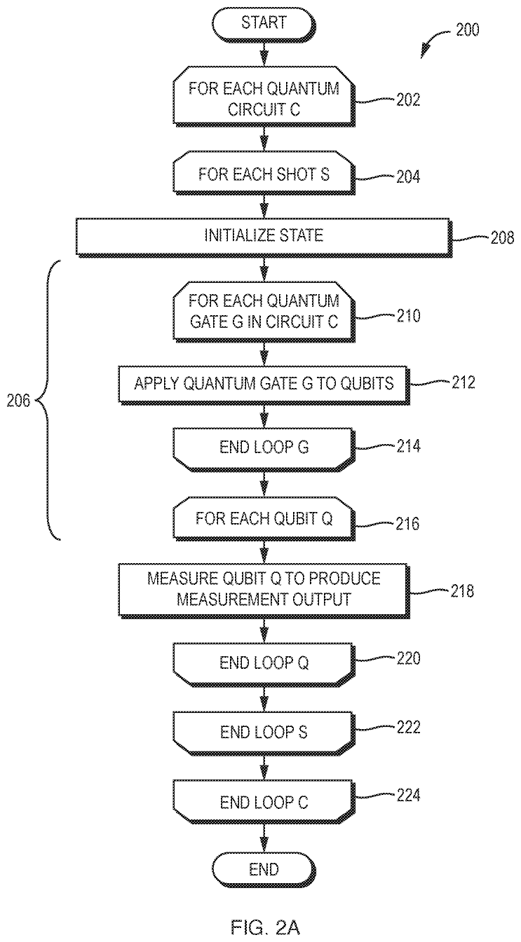

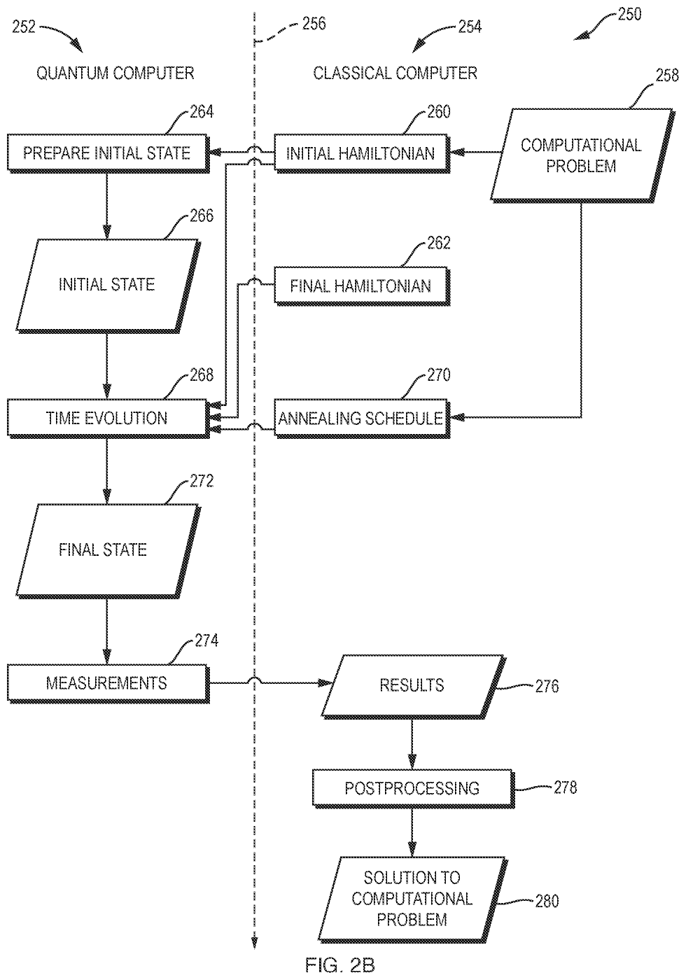

FIG. 2B shows a diagram illustrating operations typically performed by a computer system 250 which implements quantum annealing. The system 250 includes both a quantum computer 252 and a classical computer 254. Operations shown on the left of the dashed vertical line 256 typically are performed by the quantum computer 252, while operations shown on the right of the dashed vertical line 256 typically are performed by the classical computer 254.

Quantum annealing starts with the classical computer 254 generating an initial Hamiltonian 260 and a final Hamiltonian 262 based on a computational problem 258 to be solved, and providing the initial Hamiltonian 260, the final Hamiltonian 262 and an annealing schedule 270 as input to the quantum computer 252. The quantum computer 252 prepares a well-known initial state 266 (FIG. 2B, operation 264), such as a quantum-mechanical superposition of all possible states (candidate states) with equal weights, based on the initial Hamiltonian 260. The classical computer 254 provides the initial Hamiltonian 260, a final Hamiltonian 262, and an annealing schedule 270 to the quantum computer 252. The quantum computer 252 starts in the initial state 266, and evolves its state according to the annealing schedule 270 following the time-dependent Schrodinger equation, a natural quantum-mechanical evolution of physical systems (FIG. 2B, operation 268). More specifically, the state of the quantum computer 252 undergoes time evolution under a time-dependent Hamiltonian, which starts from the initial Hamiltonian 260 and terminates at the final Hamiltonian 262. If the rate of change of the system Hamiltonian is slow enough, the system stays close to the ground state of the instantaneous Hamiltonian. If the rate of change of the system Hamiltonian is accelerated, the system may leave the ground state temporarily but produce a higher likelihood of concluding in the ground state of the final problem Hamiltonian, i.e., diabatic quantum computation. At the end of the time evolution, the set of qubits on the quantum annealer is in a final state 272, which is expected to be close to the ground state of the classical Ising model that corresponds to the solution to the original computational problem 258. An experimental demonstration of the success of quantum annealing for random magnets was reported immediately after the initial theoretical proposal.

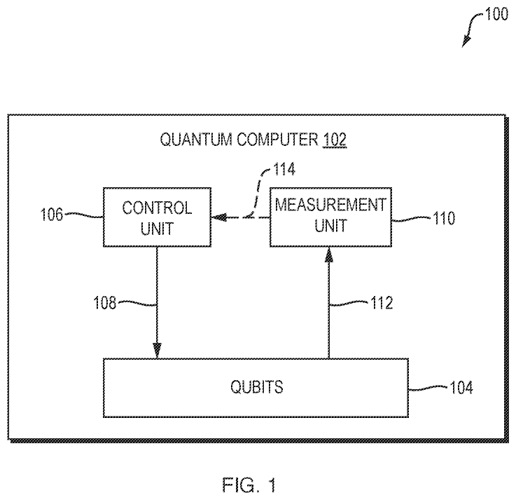

The final state 272 of the quantum computer 252 is measured, thereby producing results 276 (i.e., measurements) (FIG. 2B, operation 274). The measurement operation 274 may be performed, for example, in any of the ways disclosed herein, such as in any of the ways disclosed herein in connection with the measurement unit 110 in FIG. 1. The classical computer 254 performs postprocessing on the measurement results 276 to produce output 280 representing a solution to the original computational problem 258 (FIG. 2B, operation 278).

As yet another alternative example, embodiments of the present invention may be implemented, in whole or in part, using a quantum computer that is implemented using a one-way quantum computing architecture, also referred to as a measurement-based quantum computing architecture, which is another alternative to the gate model quantum computing architecture. More specifically, the one-way or measurement based quantum computer (MBQC) is a method of quantum computing that first prepares an entangled resource state, usually a cluster state or graph state, then performs single qubit measurements on it. It is “one-way” because the resource state is destroyed by the measurements.

The outcome of each individual measurement is random, but they are related in such a way that the computation always succeeds. In general the choices of basis for later measurements need to depend on the results of earlier measurements, and hence the measurements cannot all be performed at the same time.

Any of the functions disclosed herein may be implemented using means for performing those functions. Such means include, but are not limited to, any of the components disclosed herein, such as the computer-related components described below.

Referring to FIG. 1, a diagram is shown of a system 100 implemented according to one embodiment of the present invention. Referring to FIG. 2A, a flowchart is shown of a method 200 performed by the system 100 of FIG. 1 according to one embodiment of the present invention. The system 100 includes a quantum computer 102. The quantum computer 102 includes a plurality of qubits 104, which may be implemented in any of the ways disclosed herein. There may be any number of qubits 104 in the quantum computer 102. For example, the qubits 104 may include or consist of no more than 2 qubits, no more than 4 qubits, no more than 8 qubits, no more than 16 qubits, no more than 32 qubits, no more than 64 qubits, no more than 128 qubits, no more than 256 qubits, no more than 512 qubits, no more than 1024 qubits, no more than 2048 qubits, no more than 4096 qubits, or no more than 8192 qubits. These are merely examples, in practice there may be any number of qubits 104 in the quantum computer 102.

There may be any number of gates in a quantum circuit. However, in some embodiments the number of gates may be at least proportional to the number of qubits 104 in the quantum computer 102. In some embodiments the gate depth may be no greater than the number of qubits 104 in the quantum computer 102, or no greater than some linear multiple of the number of qubits 104 in the quantum computer 102 (e.g., 2, 3, 4, 5, 6, or 7).

The qubits 104 may be interconnected in any graph pattern. For example, they be connected in a linear chain, a two-dimensional grid, an all-to-all connection, any combination thereof, or any subgraph of any of the preceding.

As will become clear from the description below, although element 102 is referred to herein as a “quantum computer,” this does not imply that all components of the quantum computer 102 leverage quantum phenomena. One or more components of the quantum computer 102 may, for example, be classical (i.e., non-quantum components) components which do not leverage quantum phenomena.

The quantum computer 102 includes a control unit 106, which may include any of a variety of circuitry and/or other machinery for performing the functions disclosed herein. The control unit 106 may, for example, consist entirely of classical components. The control unit 106 generates and provides as output one or more control signals 108 to the qubits 104. The control signals 108 may take any of a variety of forms, such as any kind of electromagnetic signals, such as electrical signals, magnetic signals, optical signals (e.g., laser pulses), or any combination thereof.

For example:
In embodiments in which some or all of the qubits 104 are implemented as photons (also referred to as a “quantum optical” implementation) that travel along waveguides, the control unit 106 may be a beam splitter (e.g., a heater or a mirror), the control signals 108 may be signals that control the heater or the rotation of the mirror, the measurement unit 110 may be a photodetector, and the measurement signals 112 may be photons.
In embodiments in which some or all of the qubits 104 are implemented as charge type qubits (e.g., transmon, X-mon, G-mon) or flux-type qubits (e.g., flux qubits, capacitively shunted flux qubits) (also referred to as a “circuit quantum electrodynamic” (circuit QED) implementation), the control unit 106 may be a bus resonator activated by a drive, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as superconducting circuits, the control unit 106 may be a circuit QED-assisted control unit or a direct capacitive coupling control unit or an inductive capacitive coupling control unit, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as trapped ions (e.g., electronic states of, e.g., magnesium ions), the control unit 106 may be a laser, the control signals 108 may be laser pulses, the measurement unit 110 may be a laser and either a CCD or a photodetector (e.g., a photomultiplier tube), and the measurement signals 112 may be photons.
In embodiments in which some or all of the qubits 104 are implemented using nuclear magnetic resonance (NMR) (in which case the qubits may be molecules, e.g., in liquid or solid form), the control unit 106 may be a radio frequency (RF) antenna, the control signals 108 may be RF fields emitted by the RF antenna, the measurement unit 110 may be another RF antenna, and the measurement signals 112 may be RF fields measured by the second RF antenna.
In embodiments in which some or all of the qubits 104 are implemented as nitrogen-vacancy centers (NV centers), the control unit 106 may, for example, be a laser, a microwave antenna, or a coil, the control signals 108 may be visible light, a microwave signal, or a constant electromagnetic field, the measurement unit 110 may be a photodetector, and the measurement signals 112 may be photons.
In embodiments in which some or all of the qubits 104 are implemented as two-dimensionalquasiparticles called “anyons” (also referred to as a “topological quantum computer” implementation), the control unit 106 may be nanowires, the control signals 108 may be local electrical fields or microwave pulses, the measurement unit 110 may be superconducting circuits, and the measurement signals 112 may be voltages.
In embodiments in which some or all of the qubits 104 are implemented as semiconducting material (e.g., nanowires), the control unit 106 may be microfabricated gates, the control signals 108 may be RF or microwave signals, the measurement unit 110 may be microfabricated gates, and the measurement signals 112 may be RF or microwave signals.

Although not shown explicitly in FIG. 1 and not required, the measurement unit 110 may provide one or more feedback signals 114 to the control unit 106 based on the measurement signals 112. For example, quantum computers referred to as “one-way quantum computers” or “measurement-based quantum computers” utilize such feedback signals 114 from the measurement unit 110 to the control unit 106. Such feedback signals 114 are also necessary for the operation of fault-tolerant quantum computing and error correction.

The control signals 108 may, for example, include one or more state preparation signals which, when received by the qubits 104, cause some or all of the qubits 104 to change their states. Such state preparation signals constitute a quantum circuit also referred to as an “ansatz circuit.” The resulting state of the qubits 104 is referred to herein as an “initial state” or an “ansatz state.” The process of outputting the state preparation signal(s) to cause the qubits 104 to be in their initial state is referred to herein as “state preparation” (FIG. 2A, section 206). A special case of state preparation is “initialization,” also referred to as a “reset operation,” in which the initial state is one in which some or all of the qubits 104 are in the “zero” state i.e. the default single-qubit state. More generally, state preparation may involve using the state preparation signals to cause some or all of the qubits 104 to be in any distribution of desired states. In some embodiments, the control unit 106 may first perform initialization on the qubits 104 and then perform preparation on the qubits 104, by first outputting a first set of state preparation signals to initialize the qubits 104, and by then outputting a second set of state preparation signals to put the qubits 104 partially or entirely into non-zero states.

Another example of control signals 108 that may be output by the control unit 106 and received by the qubits 104 are gate control signals. The control unit 106 may output such gate control signals, thereby applying one or more gates to the qubits 104. Applying a gate to one or more qubits causes the set of qubits to undergo a physical state change which embodies a corresponding logical gate operation (e.g., single-qubit rotation, two-qubit entangling gate or multi-qubit operation) specified by the received gate control signal. As this implies, in response to receiving the gate control signals, the qubits 104 undergo physical transformations which cause the qubits 104 to change state in such a way that the states of the qubits 104, when measured (see below), represent the results of performing logical gate operations specified by the gate control signals. The term “quantum gate,” as used herein, refers to the application of a gate control signal to one or more qubits to cause those qubits to undergo the physical transformations described above and thereby to implement a logical gate operation.

It should be understood that the dividing line between state preparation (and the corresponding state preparation signals) and the application of gates (and the corresponding gate control signals) may be chosen arbitrarily. For example, some or all the components and operations that are illustrated in FIGS. 1 and 2A-2B as elements of “state preparation” may instead be characterized as elements of gate application. Conversely, for example, some or all of the components and operations that are illustrated in FIGS. 1 and 2A-2B as elements of “gate application” may instead be characterized as elements of state preparation. As one particular example, the system and method of FIGS. 1 and 2A-2B may be characterized as solely performing state preparation followed by measurement, without any gate application, where the elements that are described herein as being part of gate application are instead considered to be part of state preparation. Conversely, for example, the system and method of FIGS. 1 and 2A-2B may be characterized as solely performing gate application followed by measurement, without any state preparation, and where the elements that are described herein as being part of state preparation are instead considered to be part of gate application.

The quantum computer 102 also includes a measurement unit 110, which performs one or more measurement operations on the qubits 104 to read out measurement signals 112 (also referred to herein as “measurement results”) from the qubits 104, where the measurement results 112 are signals representing the states of some or all of the qubits 104. In practice, the control unit 106 and the measurement unit 110 may be entirely distinct from each other, or contain some components in common with each other, or be implemented using a single unit (i.e., a single unit may implement both the control unit 106 and the measurement unit 110). For example, a laser unit may be used both to generate the control signals 108 and to provide stimulus (e.g., one or more laser beams) to the qubits 104 to cause the measurement signals 112 to be generated.

In general, the quantum computer 102 may perform various operations described above any number of times. For example, the control unit 106 may generate one or more control signals 108, thereby causing the qubits 104 to perform one or more quantum gate operations. The measurement unit 110 may then perform one or more measurement operations on the qubits 104 to read out a set of one or more measurement signals 112. The measurement unit 110 may repeat such measurement operations on the qubits 104 before the control unit 106 generates additional control signals 108, thereby causing the measurement unit 110 to read out additional measurement signals 112 resulting from the same gate operations that were performed before reading out the previous measurement signals 112. The measurement unit 110 may repeat this process any number of times to generate any number of measurement signals 112 corresponding to the same gate operations. The quantum computer 102 may then aggregate such multiple measurements of the same gate operations in any of a variety of ways.

After the measurement unit 110 has performed one or more measurement operations on the qubits 104 after they have performed one set of gate operations, the control unit 106 may generate one or more additional control signals 108, which may differ from the previous control signals 108, thereby causing the qubits 104 to perform one or more additional quantum gate operations, which may differ from the previous set of quantum gate operations. The process described above may then be repeated, with the measurement unit 110 performing one or more measurement operations on the qubits 104 in their new states (resulting from the most recently-performed gate operations).

In general, the system 100 may implement a plurality of quantum circuits as follows. For each quantum circuit C in the plurality of quantum circuits (FIG. 2A, operation 202), the system 100 performs a plurality of “shots” on the qubits 104. The meaning of a shot will become clear from the description that follows. For each shot S in the plurality of shots (FIG. 2A, operation 204), the system 100 prepares the state of the qubits 104 (FIG. 2A, section 206). More specifically, for each quantum gate Gin quantum circuit C (FIG. 2A, operation 210), the system 100 applies quantum gate G to the qubits 104 (FIG. 2A, operations 212 and 214).

Then, for each of the qubits Q 104 (FIG. 2A, operation 216), the system 100 measures the qubit Q to produce measurement output representing a current state of qubit Q (FIG. 2A, operations 218 and 220).

The operations described above are repeated for each shot S (FIG. 2A, operation 222), and circuit C (FIG. 2A, operation 224). As the description above implies, a single “shot” involves preparing the state of the qubits 104 and applying all of the quantum gates in a circuit to the qubits 104 and then measuring the states of the qubits 104; and the system 100 may perform multiple shots for one or more circuits.

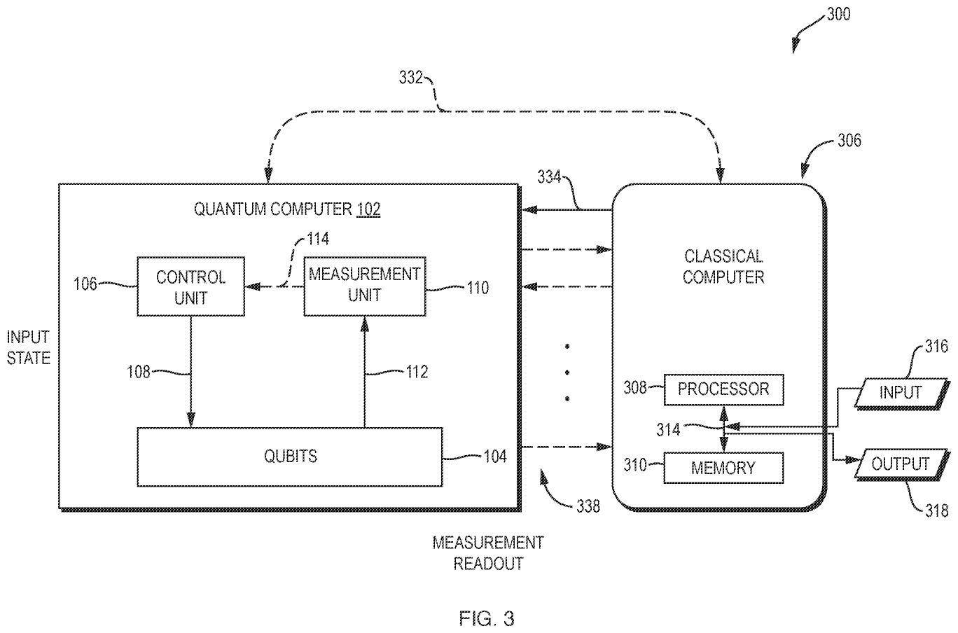

Referring to FIG. 3, a diagram is shown of a hybrid quantum classical (HQC) computer 300 implemented according to one embodiment of the present invention. The HQC 300 includes a quantum computer component 102 (which may, for example, be implemented in the manner shown and described in connection with FIG. 1) and a classical computer component 306. The classical computer component may be a machine implemented according to the general computing model established by John Von Neumann, in which programs are written in the form of ordered lists of instructions and stored within a classical (e.g., digital) memory 310 and executed by a classical (e.g., digital) processor 308 of the classical computer. The memory 310 is classical in the sense that it stores data in a storage medium in the form of bits, which have a single definite binary state at any point in time. The bits stored in the memory 310 may, for example, represent a computer program. The classical computer component 304 typically includes a bus 314. The processor 308 may read bits from and write bits to the memory 310 over the bus 314. For example, the processor 308 may read instructions from the computer program in the memory 310, and may optionally receive input data 316 from a source external to the computer 302, such as from a user input device such as a mouse, keyboard, or any other input device. The processor 308 may use instructions that have been read from the memory 310 to perform computations on data read from the memory 310 and/or the input 316, and generate output from those instructions. The processor 308 may store that output back into the memory 310 and/or provide the output externally as output data 318 via an output device, such as a monitor, speaker, or network device.

The quantum computer component 102 may include a plurality of qubits 104, as described above in connection with FIG. 1. A single qubit may represent a one, a zero, or any quantum superposition of those two qubit states. The classical computer component 304 may provide classical state preparation signals 332 to the quantum computer 102, in response to which the quantum computer 102 may prepare the states of the qubits 104 in any of the ways disclosed herein, such as in any of the ways disclosed in connection with FIGS. 1 and 2A-2B.

Once the qubits 104 have been prepared, the classical processor 308 may provide classical control signals 334 to the quantum computer 102, in response to which the quantum computer 102 may apply the gate operations specified by the control signals 332 to the qubits 104, as a result of which the qubits 104 arrive at a final state. The measurement unit 110 in the quantum computer 102 (which may be implemented as described above in connection with FIGS. 1 and 2A-2B) may measure the states of the qubits 104 and produce measurement output 338 representing the collapse of the states of the qubits 104 into one of their eigenstates. As a result, the measurement output 338 includes or consists of bits and therefore represents a classical state. The quantum computer 102 provides the measurement output 338 to the classical processor 308. The classical processor 308 may store data representing the measurement output 338 and/or data derived therefrom in the classical memory 310.

The steps described above may be repeated any number of times, with what is described above as the final state of the qubits 104 serving as the initial state of the next iteration. In this way, the classical computer 304 and the quantum computer 102 may cooperate as co-processors to perform joint computations as a single computer system.

Although certain functions may be described herein as being performed by a classical computer and other functions may be described herein as being performed by a quantum computer, these are merely examples and do not constitute limitations of the present invention. A subset of the functions which are disclosed herein as being performed by a quantum computer may instead be performed by a classical computer. For example, a classical computer may execute functionality for emulating a quantum computer and provide a subset of the functionality described herein, albeit with functionality limited by the exponential scaling of the simulation. Functions which are disclosed herein as being performed by a classical computer may instead be performed by a quantum computer.

The techniques described above may be implemented, for example, in hardware, in one or more computer programs tangibly stored on one or more computer-readable media, firmware, or any combination thereof, such as solely on a quantum computer, solely on a classical computer, or on a hybrid quantum classical (HQC) computer. The techniques disclosed herein may, for example, be implemented solely on a classical computer, in which the classical computer emulates the quantum computer functions disclosed herein.

Any reference herein to the state |0 [symbol] may alternatively refer to the state |1 [symbol] , and vice versa. In other words, any role described herein for the states |0 [symbol] and |1 [symbol] may be reversed within embodiments of the present invention. More generally, any computational basis state disclosed herein may be replaced with any suitable reference state within embodiments of the present invention.

The techniques described above may be implemented in one or more computer programs executing on (or executable by) a programmable computer (such as a classical computer, a quantum computer, or an HQC) including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention initialize a quantum state using qubit registers; apply Hadamard tests in which the unitary is a time evolution of the Hamiltonian; derive outcome samples from the Hadamard tests; using the samples, evaluate a convolution of a spectral measure and a filter function; and infer the ground state energy from the convolution. Such functions are inherently rooted in quantum computing technology and cannot be performed mentally or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

In embodiments in which a classical computing component executes a computer program providing any subset of the functionality within the scope of the claims below, the computer program may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor, which may be either a classical processor or a quantum processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A classical computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium (such as a classical computer-readable medium, a quantum computer-readable medium, or an HQC computer-readable medium). Embodiments of the invention may store such data in such data structure(s) and read such data from such data structure(s).

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method, performed on a computer system, for estimating a ground state energy of a Hamiltonian that characterizes a physical system, the computer system comprising a quantum computing component and a classical computing component,
the quantum computing component comprising a plurality of qubits;
the classical computing component comprising a classical processor and a non-transitory computer-readable memory, the non-transitory computer-readable memory storing computer instructions, which, when executed by the classical processor, perform the method, the method comprising:
causing the quantum computing component to derive outcome samples from a plurality of Hadamard tests in which a unitary is a time evolution of the Hamiltonian;
on the classical computing component, evaluating a convolution of a spectral measure and a filter function from the outcome samples; and
on the classical computing component, inferring an estimate of the ground state energy from the convolution.

2. The method of claim 1, wherein the physical system comprises a molecule.

3. The method of claim 1, wherein the physical system comprises a physical material.

4. The method of claim 1, wherein the quantum computing component comprises a fault-tolerant quantum computer.

5. The method of claim 1, wherein the quantum computing component includes a low-depth quantum circuit having an initial overlap.

6. The method of claim 5, further comprising selecting a target accuracy for the estimate of the ground state energy.

7. The method of claim 6, wherein the Hamiltonian has an inverse spectral gap of the Hamiltonian; wherein the target accuracy has an inverse of the target accuracy; and wherein the initial overlap has an inverse of the initial overlap.

8. The method of claim 7, wherein the low-depth quantum circuit has a depth that is linear in the inverse spectral gap of the Hamiltonian and poly-logarithmic in the inverse of the target accuracy and the inverse of the initial overlap.

9. The method of claim 7, wherein a runtime of the method is polynomial in the inverse spectral gap of the Hamiltonian, the inverse of the target accuracy, and the inverse of the initial overlap.

10. The method of claim 1, further comprising inferring, from the estimate of the ground state energy, a property of the Hamiltonian.

11. A hybrid quantum-classical computer system for estimating a ground state energy of a Hamiltonian that characterizes a physical system, comprising:
a quantum computing component comprising a plurality of qubits;
a classical computing component comprising a classical processor and a non-transitory computer-readable memory, the non-transitory computer-readable memory storing computer instructions, which, when executed by the classical processor, perform a method, the method comprising:
causing the quantum computing component to derive outcome samples from a plurality of Hadamard tests in which a unitary is a time evolution of the Hamiltonian;
on the classical computing component, evaluating a convolution of a spectral measure and a filter function from the outcome samples; and
on the classical computing component, inferring an estimate of the ground state energy from the convolution.

12. The hybrid quantum-classical computer system of claim 11, wherein the physical system comprises a molecule.

13. The hybrid quantum-classical computer system of claim 11, wherein the physical system comprises a physical material.

14. The hybrid quantum-classical computer system of claim 11, wherein the quantum computing component comprises a fault-tolerant quantum computer.

15. The hybrid quantum-classical computer system of claim 11, wherein the quantum computing component includes a low-depth quantum circuit having an initial overlap.

16. The hybrid quantum-classical computer system of claim 11, wherein the method further comprises selecting a target accuracy for the estimate of the ground state energy.

17. The hybrid quantum-classical computer system of claim 16, wherein the Hamiltonian has an inverse spectral gap of the Hamiltonian, wherein the target accuracy has an inverse of the target accuracy; and wherein the initial overlap has an inverse of the initial overlap.

18. The hybrid quantum-classical computer system of claim 17, wherein the low-depth quantum circuit has a depth that is linear in the inverse spectral gap of the Hamiltonian and poly-logarithmic in the inverse of the target accuracy and the inverse of the initial overlap.

19. The hybrid quantum-classical computer system of claim 17, wherein a runtime of the method is polynomial in the inverse spectral gap of the Hamiltonian, the inverse of the target accuracy, and the inverse of the initial overlap.

20. The hybrid quantum-classical computer system of claim 11, wherein the method further comprises inferring, from the estimate of the ground state energy, a property of the Hamiltonian.
